(19) United States
(12) Patent Application Publication
(10) Pub. No.: US 2026/0264048 A1
(43) Pub. Date: Sep. 10, 2026

(54) ADSORPTIVE FABRIC CONSTRUCTION WITH EMBEDDED ADSORBENT

(71) Applicant: NuMat Technologies, Inc., Chicago, IL (US)

(72) Inventors: Edwin Alfonso Argueta Fajardo, Chicago, IL (US); Nicolaas Vermeulen, Chicago, IL (US); Andrea Copeland, Chicago, IL (US); Deepak Shukla, Webster, NY (US)

(73) Assignee: NuMat Technologies, Inc., Chicago, IL (US)

(21) Appl. No.: 19/562,439

(22) Filed: Mar. 10, 2026

Related U.S. Application Data
(60) Provisional application No. 63/769,630, filed on Mar. 10, 2025.

(51) Int. Cl. B01J 20/28; B01J 20/22; B01J 20/32

(52) U.S. Cl. CPC B01J 20/28035; B01J 20/226; B01J 20/3206; B01J 20/3223; B01J 20/324

(57) ABSTRACT

A multi-layer fabric construction to mitigate toxic chemical agents, the construction comprises a gas-permeable carbon layer and a gas-permeable adsorbent layer comprising a web of entangled organic polymeric microfibers and a plurality of particles of a metal organic framework (MOF) material substantially uniformly dispersed in the web. The construction may include an inner fabric layer, a vapor-permeable layer and an outer fabric layer.

### FIELD OF THE DISCLOSURE

The present disclosure relates generally to multi-layer fabric constructions that can include a carbon-based material and/or a metal organic framework adsorptive material to mitigate toxic chemical agents, to methods of making the multi-layer fabric constructions, and to articles made from the multi-layer fabric constructions.

### BACKGROUND OF THE DISCLOSURE

Humans routinely encounter airborne contaminants in the form of toxic chemical agents (TCAs), such as pesticides, herbicides, toxic industrial chemicals (TICs), and even chemical warfare agents (CWAs), with many occupations requiring the use of personal protective equipment (PPE) in order to ensure worker safety. At present, the common mechanisms for chemical protection include repulsion, sorption, and decontamination. While each individual mechanism has its own advantages and disadvantages, a need exists for protective materials that can be made into apparel and offer protection against TCAs, through sorptive and decomposition mechanisms.

One potential solution to this need is to manufacture protective apparel from fabric constructions that include one or more layers that are impervious to vapors and airborne contaminants, such as layers comprising natural or synthetic rubber materials. These materials, once integrated into the PPE, would repel agents offering protection to the user; however, such impervious layers entrap heat and moisture naturally emitted from the wearer's skin, such that the impervious PPE becomes intolerably uncomfortable within a very short period of time, particularly when worn in hot environments. It is therefore desirable to provide protective apparel that both limits the inward flow of airborne toxic chemical agents yet permits the outward flow of naturally produced moisture and heat.

Since TCAs have a broad range of applications, ranging from industry to warfare, various standards are used to evaluate PPE ensuring users will be protected from these toxic chemicals. These standards are developed and maintained by a multitude of organizations, including the National Fire Protection Agency (NFPA) and the International Organization for Standardization (ISO), to evaluate whether the manufactured PPE protects its users from TCAs, to ensure the PPE will operate under harsh conditions (high temp, % RH), and to guarantee the garment's durability. While multiple standards have been written to address several distinct and specific situations, a tradeoff has emerged, over time, between the wearability of a protective garment and the protection levels of the PPE.

In response, a series of standards have been written to address different situations. These standards target protection at different threat levels from low concentration short exposure through to high concentration long exposure. When garments are produced to address these standards there are tradeoffs between wearability and chemical protection.

One factor in this tradeoff is based on the environment and use of the PPE. In an industrial setting, for example, the primary mechanism for chemical agent protection is to create an impermeable barrier between the user and toxic chemical agent. Most of these solutions employ per- and polyfluoroalkyl substances (PFAS) as a primary mode of protection to repel agents from the surface of the protective fabric (e.g., NFPA Class III in the United States). These textile architectures offer protection to the user but limit fabric dexterity and result in a significant thermal burden when employed by the user. Alternatively, in hostile environments where toxic chemical agents may be used as a chemical weapon, it is critical to provide the individual with PPE with enhanced or more rigorous standards of protection that will shield them from toxic chemical agents.

To overcome some of limitations of the standard barrier materials, it is possible to employ sorptive materials in protection solutions. One form of protective apparel is based on fabric constructions incorporating activated carbon, typically in the form of particles or granules disposed between layers of fabric. For example, a Joint Service Lightweight Integrated Suit Technology (JSLIST) liner used for protective apparel comprises a nonwoven front layer, laminated to activated carbon spheres and bonded to a knitted back that adsorbs chemical agents. These garments offer the individual some wearability advantages when compared to PPE used in industrial applications at the expense of protection. However, carbon as a sorptive material has its own limitations and to achieve the protection goals, JLIST fabric must integrate an air gap into its construction. The air gap allows for protection goals to be met but act as insulation to increase the thermal burden significantly, such that apparel made from such fabric constructions can become uncomfortable during extended use by the user.

Efforts have been made to eliminate the insulating air pockets from protective apparel by bonding activated carbon particles or granules to one or more internal surfaces of a fabric construction via an appropriate adhesive. Certain adhesives can make the resulting fabric stiff and brittle and, therefore, very uncomfortable for the wearer. Furthermore, when these adhesives are used laminate stability is low that can lead to breakdown of the laminate when deployed by the user. Finally, it should be noted that, when carbon is employed as the sorptive layer, removal of the air gap results in the fabrics failing to meet established protection standards, thereby limiting the protective function of the garment.

Moreover, activated carbon at best only adsorbs TCAs, but it does not decompose or otherwise deactivate TCAs. It would be desirable to provide a protective material that both adsorbs and deactivates toxic chemical agents on relevant time scales.

Certain metal hydroxides and hydrous metal oxides, including zirconium hydroxide (often described as hydrous zirconia, Zr(OH)₄), have been reported to detoxify organophosphorus nerve agents and related toxic compounds via surface-mediated hydrolysis or other decomposition pathways. However, such materials may have limited capacity as standalone vapor sorbents and may exhibit performance sensitivity to environmental conditions (e.g., humidity, competitive adsorption, and deactivation), depending on formulation and deployment. Accordingly, protective systems that combine effective capture of toxic agents with chemical degradation capability are desirable for next-generation PPE.

Applicants have developed fabric constructions with metal organic framework (MOF) materials for the neutralization of TCAs in an effort to develop PPE suitable for providing protection materials for both civilian and military use. For example, U.S. Patent Publication 2024/0408571 A1, assigned to the common assignee, discloses a multi-layer adsorptive fabric construction that can offer protection against a variety of airborne toxic agents, the construction comprising a carbon layer, a gas-permeable adsorbent layer comprising a metal organic framework material and an adhesive, a vapor-permeable layer, and an outer face fabric.

It is thus an object of the disclosure to provide a gas-permeable fabric construction that can offer a user protection against a variety of TCAs, without imposing an undue thermal burden on the user and while providing sufficient elasticity or resilience to be reasonably comfortable for a user over an extended period of use.

It is yet another object of the disclosure to provide articles made from a gas-permeable fabric construction that can offer a user protection against a variety of airborne TCAs.

It is yet another object of this disclosure to provide articles that conform to both industrial and military standards and to provide articles that destroy CWAs.

It is yet another object of this disclosure to establish laminates that can achieve shelf-life and laundering goals.

Aspects of the present disclosure may solve one or more of the problems set forth above and/or other problems in the art. The scope of the current disclosure, however, is defined by the attached claims, and not by the ability to solve any specific problem.

### SUMMARY OF THE DISCLOSURE

Disclosed herein is a multi-layer (or multi-layered) fabric construction configured to mitigate liquid and airborne toxic chemical agents, the construction comprising at least one gas-permeable adsorbent layer and at least one vapor-permeable layer. The gas-permeable adsorbent layer comprises a porous, three-dimensional nonwoven scaffold of entangled polymeric microfibers and a plurality of adsorbent particles mechanically retained within the scaffold at one or more depths. The vapor-permeable layer has an inner face and an outer face, with the inner face disposed toward the gas-permeable adsorbent layer.

In certain embodiments, the adsorbent particles comprise metal-organic framework (MOF) material, activated carbon, or combinations thereof. The MOF particles and activated carbon particles may be present in separate gas-permeable layers or co-located within a common nonwoven scaffold. In embodiments comprising both MOF and activated carbon within a gas-permeable adsorbent layer, the relative proportions of MOF and activated carbon may be selected to achieve desired adsorption capacity, degradation performance, or service life characteristics.

In certain embodiments, the vapor-permeable layer comprises a permeable dispersion membrane configured to spatially redistribute vapor-phase and aerosolized toxic chemical agents prior to contact with the gas-permeable adsorbent layer. The vapor-permeable layer further permits outward transmission of moisture vapor generated by a wearer.

In certain embodiments, the construction further comprises an optional outer face fabric disposed outwardly of the vapor-permeable layer. The outer face fabric may provide durability, environmental resistance, and optional liquid repellency.

In certain embodiments, the construction further comprises a gas-permeable carbon-containing layer disposed adjacent the gas-permeable adsorbent layer. The carbon-containing layer may comprise activated carbon cloth, activated carbon particles, activated carbon beads or granules, or activated carbon mechanically retained within a nonwoven scaffold. The carbon-containing layer may be secured to adjacent layers using one or more gas-permeable adhesive layers.

In certain embodiments, the construction may include a secondary MOF-containing layer comprising MOF particles in the form of beads, granules, or composite shaped bodies. The relative positioning of MOF-containing and carbon-containing layers may be selected to provide staged adsorption and/or degradation of toxic chemical agents.

In certain embodiments, adjacent functional layers are positioned in direct or substantially direct contact such that the construction is substantially free of intentional insulating air gaps between layers.

In certain embodiments, MOF particles are formed into shaped bodies comprising MOF material and one or more binders.

In certain embodiments, the shaped bodies comprise MOF-alginate beads or other polymer-bound composite bodies.

In certain embodiments, the MOF material comprises a zirconium-based MOF.

In certain embodiments, the MOF comprises linker molecules bearing amino functionality.

In certain embodiments, at least a portion of the linker sites comprise NH₂ substituents.

In certain embodiments, the MOF material is further impregnated with one or more inorganic metal salts or catalytic species.

In certain embodiments, the MOF particles are present in a gas-permeable adsorbent layer at a loading of about 50 wt % to about 95 wt % relative to total layer weight.

Also disclosed herein is a method of manufacturing a multi-layer fabric construction comprising: (a) providing a gas-permeable nonwoven adsorbent layer comprising a porous microfiber scaffold and a plurality of adsorbent particles mechanically retained therein; (b) providing a subassembly comprising a vapor-permeable layer and optionally an outer face fabric secured thereto; and (c) securing the gas-permeable nonwoven adsorbent layer to the subassembly.

In certain embodiments, the layers are secured by lamination using one or more gas-permeable adhesive layers, including thermal, reactive, or pressure-assisted lamination processes.

In certain embodiments, the adsorbent particles are distributed within the scaffold in surface-biased, stratified, or multi-depth arrangements while maintaining gas permeability.

Also disclosed herein is a garment comprising the multi-layer fabric construction described herein.

Also disclosed herein is a filter or filtration device comprising the multi-layer fabric construction described herein.

### DESCRIPTION OF THE FIGURES

FIG. 1 is a simplified illustration of one embodiment of a multi-layer fabric construction according to the invention.

FIG. 2 is a simplified illustration of one embodiment of one of the layers of a multi-layer fabric construction.

FIG. 3 is an exploded cross-sectional view of the multi-layer fabric construction of FIG. 1.

FIG. 4 is a simplified illustration of one embodiment of a multi-layer fabric construction of the disclosure showing the arrangement of the various layers and showing gas-permeable layers with multiple layers of adsorbent particles encapsulated within said gas-permeable layers.

FIG. 5 is a simplified illustration of an embodiment of a multi-layer fabric construction of the disclosure showing the arrangement of the various layers, with the gas-permeable layer comprising of a mixture of MOF material and carbon.

FIG. 6 is an exploded cross-sectional illustration of an embodiment in which a mixture of web adhesives and adhesive dots are used to put the multi-layer fabric together.

FIG. 7 is a simplified illustration of an embodiment of a multi-layer fabric construction of the disclosure showing the use of web adhesives to adhere all layers together.

FIG. 8 is another simplified illustration of FIG. 5 showing multiple layers of a MOF material and carbon mixed within a gas-permeable layer.

FIG. 9 is a simplified illustration of an embodiment of a multi-layer fabric construction of the disclosure showing the location of the vapor-permeable layer between the MOF material layer and the carbon layer.

FIG. 10 is a simplified illustration of an embodiment of a multi-layer fabric construction of the disclosure showing the location of the vapor-permeable layer below the carbon layer.

FIG. 11 is a simplified illustration of an embodiment of a multi-layer fabric construction of the disclosure showing the use of two gas-permeable materials with MOF material in both layers.

FIG. 12 is a simplified illustration of an embodiment of a multi-layer fabric construction of the disclosure showing the use of one gas-permeable layer with MOF material.

FIG. 13 is a simplified illustration of an embodiment of a multi-layer fabric construction of the disclosure showing the use of two gas-permeable materials with carbon in both layers.

FIG. 14 is a simplified illustration of an embodiment of a multi-layer fabric construction of the disclosure showing the use of carbon particles adhered to an inner face fabric.

FIG. 15 is a simplified illustration of an embodiment of a multi-layer fabric construction of the disclosure showing the use of a gas-permeable layer with carbon particles adhered to it via an adhesive.

FIG. 16 is a simplified illustration of an embodiment of a multi-layer fabric construction of the disclosure showing the use of two vapor-permeable layers, one gas-permeable layer with MOF material, and one gas-permeable layer with activated carbon material.

FIG. 17 is a simplified illustration of an embodiment of a multi-layer fabric construction of the disclosure showing the use of one vapor-permeable layer, one gas-permeable layer with MOF material, and one gas-permeable layer with activated carbon material

FIG. 18 is a simplified illustration of an embodiment of a multi-layer fabric construction of the disclosure showing the use of two vapor-permeable layers and two gas-permeable layers with activated carbon material.

FIG. 19 illustrates a first apparatus to be used to prepare a web or scaffold of entangled spun-blown organic polymeric microfibers and the uniform distribution of MOF material or carbon particles into the web of microfibers for use in the multi-layer fabric construction.

FIG. 20 illustrates a second apparatus to be used to prepare a web or scaffold of entangled spun-blown organic polymeric microfibers and the uniform distribution of MOF material or carbon particles into the web of microfibers for use in the multi-layer fabric construction.

FIG. 21 is a photograph of a representative garment using a multi-layer fabric construction.

FIG. 22 is an SEM image of MOF particles mechanically retained within the scaffold.

FIG. 23 is an SEM image of carbon particles mechanically retained within the scaffold.

FIG. 24 is an SEM image of non-spherical granules mechanically retained within the scaffold.

FIG. 25 is a photograph of a cross section of an intermediate nonwoven scaffold in three layers with comingled particles.

FIG. 26 is a photograph of an edge and a top of an intermediate nonwoven scaffold layer with comingled particles.

### DETAILED DESCRIPTION OF THE DISCLOSURE

Both the foregoing general description and the following description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

As used herein, the phrase “inner face” of a layer refers to that face that is toward the person who is wearing the multi-layer fabric construction as disclosed herein, or toward the object to be protected by the multi-layer fabric construction as disclosed herein.

As used herein, the phrase “outer face” of a layer refers to that face that is away from the person who is wearing the multi-layer fabric construction as disclosed herein, or away from the object to be protected, and toward the environment that contains one or more airborne toxic chemical agents.

As used herein, when a face is described as “facing” or “toward” another face, it may be in direct contact with that face or there may be additional layers disposed between.

“Adhesive layer” refers to a layer comprising an adhesive material and configured to bond adjacent layers while permitting passage of gas therethrough.

As used in herein describing a three-dimensional non-woven web or scaffold, the term “scaffold” is not limited to any particular fiber orientation, density, or thickness and encompasses structures having particles distributed uniformly, substantially uniformly, or in stratified arrangements at various depths. The scaffold provides spatial locations for encapsulation, entrapment, or mechanical interlocking of adsorbent particles at multiple depths within the structure, rather than limiting the particles to a single planar layer.

In certain embodiments, the scaffold is stratified, meaning that fibers and particles are distributed throughout the thickness of the structure in a manner that creates tortuous flow paths for gases or vapors passing through the material. The scaffold maintains sufficient void volume to preserve gas permeability while physically stabilizing the dispersed particles against migration, settling, or agglomeration during handling, lamination, laundering, or use.

In addition to supporting active particles, the scaffold may contribute mechanical integrity to the overall multi-layer fabric construction, including tensile strength, flexibility, compressibility, and resilience. The scaffold may be formed from organic polymeric microfibers produced by processes such as melt-blowing, spun-blowing, electrospinning, extrusion, or combinations thereof.

In certain embodiments, the scaffold comprises spun-blown microfibers formed by extruding a thermoplastic polymer through a plurality of spinnerets and attenuating the polymer streams using high-velocity gas to form fine fibers that are collected into a cohesive nonwoven matrix. One or more die heads may be employed to generate layered or stratified microfiber structures. The scaffold is not limited to spun-blown processes and may alternatively be produced by melt-blowing, electrospinning, solution blowing, extrusion, carding and thermal bonding, or combinations thereof, provided that a porous, mechanically stable structure capable of retaining adsorbent particles is formed.

The nonwoven scaffold may comprise microfibers having an average fiber diameter of approximately 0.5 microns to 50 microns, including embodiments in the range of 0.5 microns to 15 microns or 1 micron to 10 microns. The fibers may be continuous filaments or discontinuous fibers and may have lengths ranging from sub-millimeter lengths to several centimeters or may extend continuously across the web. The fibers are arranged in an entangled, interlocked configuration forming a lofted, three-dimensional porous network having interconnected voids that permit gas flow while mechanically retaining adsorbent particles within the scaffold. Particle retention may be achieved primarily through mechanical interlocking between the fibers and the particles rather than full encapsulation by adhesive.

The scaffold may have a basis weight of at least about 0.5 gsm and, in certain embodiments particularly suited for supporting adsorbent beads having an average diameter of about 300 microns to about 600 microns, may have a basis weight of about 10 gsm to about 300 gsm, including embodiments of about 20 gsm to about 200 gsm or about 30 gsm to about 150 gsm. The scaffold may have an uncompressed thickness of about 50 microns to about 2000 microns, including embodiments of about 200 microns to about 1500 microns or about 300 microns to about 1200 microns. In certain embodiments, the scaffold thickness is selected relative to bead size such that the beads are primarily supported near a surface of the scaffold while at least a portion of the beads partially embed into the scaffold to provide mechanical anchoring without substantially obstructing gas permeability. The scaffold may further be engineered to provide sufficient tensile strength, compressive resilience, recovery after compression, and flexibility to withstand lamination, garment fabrication, laundering, and operational use without substantial particle migration, loss, redistribution, or collapse of the porous structure. In certain embodiments, the scaffold comprises multiple stratified microfiber sub-layers that collectively create a tortuous gas flow path through the adsorbent layer, increasing contact probability between airborne toxic chemical agents and the adsorbent particles.

The scaffold may function both as a carrier for active adsorbent materials and as a structural component within the multi-layer fabric construction 10. The scaffold comprises a porous, three-dimensional network of entangled polymeric microfibers defining interconnected voids that permit gas flow therethrough. Adsorbent particles or materials, including MOF particles or materials and/or activated carbon particles or materials, may be retained within the scaffold through mechanical interlocking with the fibers, partial embedding within softened or consolidated fibers, or positional confinement within the interconnected void structure. In certain embodiments, particles may be distributed throughout the thickness of the scaffold in a stratified or multi-depth arrangement. In other embodiments, the particle distribution may be surface-biased, such that a majority of the particles are located proximate to one face of the scaffold while a smaller fraction resides below the surface. The particles may be partially embedded within the fibrous network but are not fully encapsulated, thereby maintaining accessible external surface area and internal porosity for adsorption and/or degradation. The scaffold architecture is configured to preserve gas permeability while stabilizing the particles against migration or shedding during handling and use.

As used herein, the term “toxic chemical agents” or “TCAs” refers broadly to hazardous chemical substances capable of causing injury, incapacitation, illness, or death upon inhalation, dermal exposure, or other forms of contact. TCAs include, without limitation, toxic industrial chemicals (TICs), chemical warfare agents (CWAs), pesticides, and related hazardous compounds.

Toxic industrial chemicals (TICs) include commercially manufactured, stored, transported, or used chemicals that may pose acute or chronic health risks if released into the environment. Representative TICs include, but are not limited to, ammonia, arsine, acetaldehyde, boron trichloride, boron trifluoride, carbon disulfide, chlorine, diborane, dimethyl sulfate, ethylene oxide, fluorine, formaldehyde, hydrogen bromide, hydrogen chloride, hydrogen cyanide, hydrogen fluoride, hydrogen sulfide, fuming nitric acid, phosgene, phosphorous trichloride, sulfur dioxide, sulfuric acid, tungsten hexafluoride, and other chemically similar substances.

Chemical warfare agents (CWAs) include highly toxic chemical compounds developed or utilized for military or terrorist purposes. Examples of CWAs include, without limitation, cyanogen chloride (CK), sulfur mustard (HD), hydrogen cyanide (AC), lewisite (L), A-series agents such as A-234, phosgene (CG), sarin (GB), soman (GD), tabun (GA), TGD, VX, and structurally related nerve agents, vesicants, choking agents, blood agents, and mixtures thereof.

Pesticides include chemical agents intended to control or eliminate pests and may include insecticides, herbicides, fungicides, rodenticides, nematicides, and similar agricultural or industrial chemicals that may present inhalation or dermal hazards.

The term “toxic chemical agents” further encompasses vapors, aerosols, liquid droplets, and particulate forms of the foregoing substances, as well as degradation products, hydrolysis products, and reactive intermediates generated from such substances.

The TCAs contemplated herein may be present in vapor-phase, aerosolized, or liquid challenge conditions, including high humidity and elevated temperature environments.

The foregoing examples are illustrative and not limiting, and the term “toxic chemical agents” is intended to include chemically related compounds having similar toxicological profiles or functional reactivity.

As used herein, “pesticides” are substances that are meant to control pests. A pesticide can be any of an herbicide, insecticide, nematicide, molluscicide, piscicide, avicide, rodenticide, bactericide, insect repellent, animal repellent, microbicide, fungicide, and lampricide.

As used herein, the term “uniform” refers to a parameter-such as distribution, spacing, concentration, loading, thickness, or rate—that is substantially consistent across a defined region or over a defined interval.

“Uniform” does not require absolute mathematical constancy, but instead indicates the absence of substantial localized variation, clustering, gradients, or discontinuities that would materially affect the intended function or performance.

In certain embodiments, uniformity may correspond to variation of no more than approximately ±5% from a mean value across a defined measurement area. The defined measurement area may comprise a region of about 1 cm² to about 100 cm², or other representative sampling area selected based on particle size and layer thickness. In other embodiments, acceptable variation may be within ±10%, depending on the nature of the material or process. When referring to particle distributions, uniform indicates that particles are dispersed in a manner that avoids macroscopic agglomeration or large void regions.

When referring to process variables such as feed rate, deposition rate, or line speed, uniform indicates that such variables are maintained within controlled limits sufficient to produce consistent material properties.

Accordingly, “uniform” encompasses distributions or rates that remain functionally consistent for purposes of achieving reproducible adsorption, permeability, or mechanical performance.

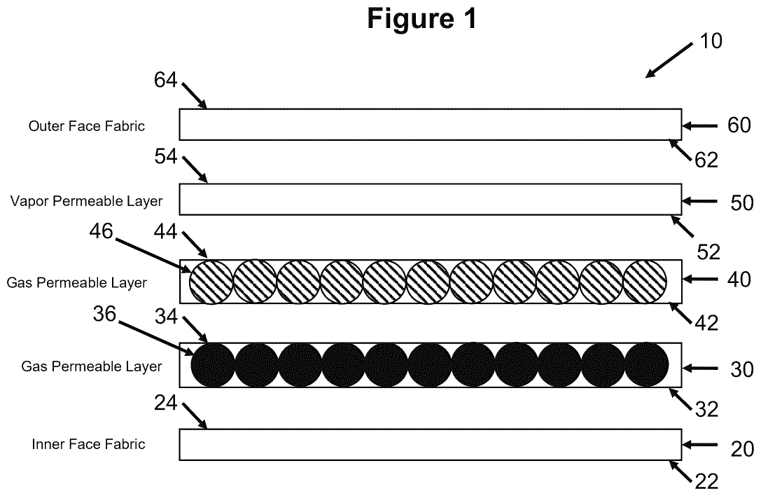

FIG. 1 illustrates across-sectional view of one embodiment of a multi-layer fabric construction 10. The multi-layer fabric construction 10 protects a user from exposure to liquid and airborne toxic chemical agents. The multi-layer fabric construction 10 may be incorporated into protective articles, including garments, that shield the wearer from airborne toxic chemical agents while maintaining breathability and wear comfort. The multi-layer fabric construction may include multiple gas-permeable adsorbent layers employed in series to enhance adsorption capacity, degradation performance, or both.

### Inner Fabric Layer

The multi-layer fabric construction 10 illustrated in FIG. 1 includes an inner fabric layer 20. The inner fabric layer 20 is primarily provided to enhance wearer comfort when the multi-layer fabric construction 10 is incorporated into a protective garment. The inner fabric layer 20 is positioned adjacent to the wearer and may be in direct contact with the wearer's skin. As shown in FIG. 1, the inner fabric layer 20 includes an inner fabric layer inner face 22 oriented toward the user and an opposing inner fabric layer outer face 24 facing the adjacent layer of the multi-layer fabric construction 10.

The inner fabric layer 20 is preferably formed from a soft, flexible, and vapor-permeable material that permits the transmission of moisture vapor generated by perspiration and facilitates the wicking of liquid sweat away from the skin. Suitable materials include woven fabrics, knitted fabrics, stitched fabrics, laminated textiles, textile composites, fleece materials, and nonwoven fabrics. The selected material may be engineered to balance softness, breathability, durability, and mechanical integrity.

The inner fabric layer 20 is preferably air-permeable and water-vapor-permeable so as not to materially impede moisture transport through the multi-layer fabric construction 10. At the same time, it should possess sufficient tensile strength and dimensional stability to support bonding to adjacent layers and to withstand garment fabrication, laundering, and operational use.

While the inner fabric layer 20 improves comfort and wearability, it is not required for the chemical protective function of the multi-layer fabric construction 10. Accordingly, the inner fabric layer 20 is an optional component and may be omitted in certain embodiments without materially affecting the adsorption and/or decontamination performance of the multi-layer fabric construction 10.

### Gas-Permeable Carbon Layer

The multi-layer fabric construction 10 further includes a gas-permeable carbon layer 30. In one embodiment the gas-permeable carbon layer 30 is formed from a three-dimensional non-woven web or scaffold (as discussed above) of entangled organic polymeric microfibers and a plurality of carbon particles 36 substantially uniformly dispersed throughout and mechanically retained in the web. In alternate embodiments the gas-permeable carbon layer 30 may be a woven material such as a carbon cloth or a felt material. In embodiments in which the gas-permeable carbon layer 30 comprises a nonwoven structure, the gas-permeable carbon layer 30 may be formed as a porous, three-dimensional scaffold of entangled polymeric microfibers mechanically retaining activated carbon particles 36 therein. Such scaffold-based constructions are structurally distinct from dip-coated textile systems in which a fabric substrate is saturated or impregnated with an adsorbent-containing emulsion. The gas-permeable carbon layer 30 has a gas-permeable carbon layer inner face 32 and an opposing gas-permeable carbon layer outer face 34. As illustrated in FIG. 1, the gas-permeable layer carbon inner face 32 is adjacent to the inner fabric layer outer face 24. The gas-permeable carbon layer 30 may be omitted in alternate embodiments of the multi-layer fabric construction 10.

As mentioned above, the gas-permeable carbon layer 30 may be provided in various gas-permeable forms, including activated carbon cloth, activated carbon felt, carbon-impregnated membranes. In certain embodiments, the activated carbon is present as an integral textile layer, such as a woven or knitted carbon fabric, which facilitates handling and lamination during manufacturing. Knit activated carbon fabrics may provide enhanced flexibility, stretch, and wearer mobility when incorporated into protective garments. Woven carbon fabrics may provide increased dimensional stability. Commercially available activated carbon fabrics include, without limitation, materials sold under the brand names Zorflex, Stedcarb, and Flexzorb, although the invention is not limited to any specific supplier or product and any material that provides acceptable results may be used.

The gas-permeable carbon layer 30 preferably comprises activated carbon and is configured to provide broad-spectrum adsorption of airborne toxic chemical agents. The gas-permeable carbon-layer 30 may function as a supplemental adsorbent stage positioned upstream or downstream of the gas-permeable adsorbent layer 40, thereby increasing overall adsorption capacity and extending service life of the construction.

In embodiments where activated carbon is present as an integral textile layer, the carbon loading may be at least about 10 gsm, or at least about 20 gsm, or at least about 30 gsm, or at least about 40 gsm, or at least about 50 gsm, or at least about 60 gsm, or at least about 70 gsm, or at least about 80 gsm, or at least about 90 gsm, or at least about 100 gsm, measured as active carbon content. Higher loadings are also contemplated, provided that gas permeability and flexibility are maintained.

In certain embodiments, the gas-permeable carbon-containing layer 30 comprises activated carbon material in particulate form, including activated carbon particles, beads, granules, or other shaped bodies 36. The activated carbon particles, beads, granules or other shaped bodies 36 are dispersed on a nonwoven scaffold.

In embodiments where activated carbon material is provided in particulate form, the particles 36 may have an average size in the range of about 200 microns to about 1000 microns, including embodiments of about 300 microns to about 800 microns, about 300 microns to about 600 microns, about 400 microns to about 600 microns, or about 400 microns to about 500 microns. The activated carbon may be formed into beads, granules, agglomerates, or other mechanically robust bodies within these size ranges, provided that gas permeability of the layer is maintained.

As used herein, the term “activated carbon” refers broadly to carbonaceous materials having a developed internal pore structure and high specific surface area suitable for adsorption of toxic chemical agents. Activated carbon may be derived from coal, wood, coconut shell, petroleum pitch, synthetic polymers, or other carbon precursors, and may be produced by physical or chemical activation processes.

The term “activated carbon” encompasses both non-impregnated activated carbon and activated carbon that has been impregnated or otherwise treated with one or more active ingredients to enhance adsorption selectivity and/or chemical reactivity. Suitable impregnants include, without limitation, amines, metal salts, metal oxides, hydroxides, carbonates, and combinations thereof. In one embodiment, the activated carbon is impregnated with triethylenediamine (TEDA). Other suitable impregnants may include copper salts, zinc salts, silver salts, molybdenum compounds, or mixtures of two or more such materials. Alternate embodiments may use any impregnants that achieve suitable results.

Activated carbon as used herein may be present in various physical forms, including powders, granules, beads, spheres, fibers, cloth, felts, foams, or composite structures. In certain embodiments, the activated carbon has a BET surface area of at least about 500 m²/g, or at least about 800 m²/g, or at least about 1000 m²/g. The pore structure may include micropores, mesopores, and/or macropores, and may be tailored to preferentially adsorb vapor-phase toxic industrial chemicals (TICs), chemical warfare agents (CWAs), or decomposition byproducts thereof.

Activated carbon may function primarily as a broad-spectrum adsorbent and, in impregnated embodiments, may additionally facilitate chemisorption, catalytic decomposition, or neutralization of selected toxic chemical agents.

### Gas-Permeable Adsorbent Layer

The multi-layer fabric construction 10 illustrated in FIG. 1 includes gas-permeable adsorbent layer 40. The gas-permeable adsorbent layer 40 has a gas-permeable adsorbent layer inner face 42 and an opposing gas-permeable adsorbent layer outer face 44. As illustrated in FIG. 1, the gas-permeable adsorbent layer inner face 42 is adjacent the gas-permeable carbon layer inner face 32. The gas-permeable adsorbent layer 40 may provide both adsorption and chemical degradation activity with respect to one or more airborne toxic chemical agents with both MOF materials 46 and activated carbon material 36. Where MOF materials 46 are present, the gas-permeable adsorbent layer 40 may be configured to chemically decompose at least a portion of the toxic chemical agents upon contact. Where activated carbon material 36 is present, the gas-permeable adsorbent layer 40 may provide broad-spectrum adsorption and may optionally include impregnated species that promote chemisorption or catalytic reactivity.

The gas-permeable adsorbent layer 40 comprises a scaffold or a three-dimensional microfiber scaffold, of entangled polymeric microfibers and a plurality of adsorbent particles mechanically retained within the scaffold. The adsorbent material 46 may comprise a MOF material 46, activated carbon material 36, or a combination thereof. The MOF material 46 may be present as primary MOF crystallites, powders comprising agglomerated crystallites, granules, beads, composite bodies, pellets, extrudates, or other shaped bodies comprising MOF material. As used herein, “primary crystallites” refers to individual crystalline domains of MOF In certain embodiments, the MOF material 46 comprises a zirconium-based MOF.

As used herein, MOF materials 46 may have a variety of morphologies and are not limited to particles or powders. MOF materials may be particles that are spherical, substantially spherical, spheroidal, ellipsoidal, faceted, angular, irregular, distorted, tear-shaped, lobed, spiked, dendritic, or otherwise non-spherical. In certain embodiments, the particle surface may include asperities or protrusions that enhance mechanical interlocking with the surrounding microfiber scaffold. The MOF material 36 may be MOF particles that are monodisperse, polydisperse, or bimodal in size distribution.

Additionally, MOF materials 46 may be in the form of beads, granules, or other shaped bodies that allow for controlled loading and spatial distribution of the MOF within the scaffold and can enable higher active loadings relative to thin coatings or dip-treated textiles. The MOF material 46 may be present across the area of the gas-permeable adsorbent layer 40 at loadings of at least about 50 gsm, or at least about 100 gsm, or at least about 150 gsm, or at least about 200 gsm, or at least about 250 gsm, or at least about 300 gsm, or at least about 350 gsm, or at least about 400 gsm, measured as active MOF content.

In certain embodiments, the MOF-material 46 is a bead, granule or other shaped body and has an average size in the range of about 150 microns to about 1000 microns, including embodiments of about 200 microns to about 1000 microns, about 250 microns to about 800 microns, about 300 microns to about 600 microns, or about 300 microns to about 400 microns. In some embodiments, particles 46 may have diameters of at least about 100 microns, 200 microns, 300 microns, 400 microns, 500 microns, 600 microns, 700 microns, 800 microns, 900 microns, or 1000 microns.

In one embodiment, the MOF material 46 is present in the form of composite beads comprising MOF and a polymeric binder, such as MOF-alginate beads. The MOF may constitute about 50 wt % to about 99 wt % of the total solids content of the composite bead on a dry-weight basis. In certain embodiments, the MOF constitutes about 70 wt % to about 95 wt % of the total solids content. Suitable binders include alginate, Ludox, PVP, PVDF, and other inorganic or organic binders known in the art. The composite beads may have a size ranging from about 200 microns to about 1000 microns and a bulk density ranging from about 0.3 to about 0.6 cc/g. The invention is not limited to spherical beads, and the composite bodies may exhibit spherical, irregular, faceted, distorted, or surface-textured morphologies.

In embodiments in which the MOF material 46 is formed into composite bodies 46, including beads, granules, or other shaped bodies, one or more binders may be employed to enhance structural integrity, abrasion resistance, and resistance to fragmentation during handling and use. Suitable binders may include natural polymers, synthetic polymers, inorganic binders, or combinations thereof, provided that the binder does not materially impair gas accessibility to the MOF surface or internal porosity.

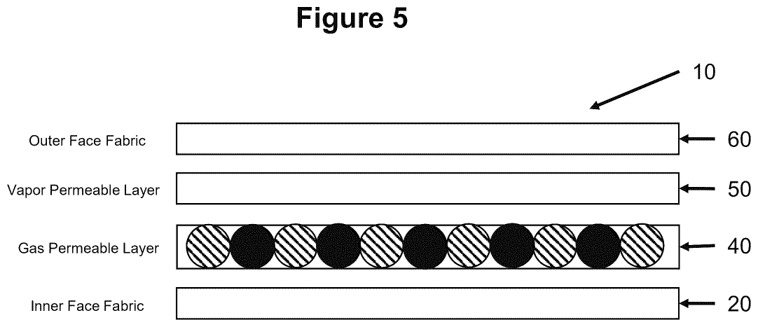

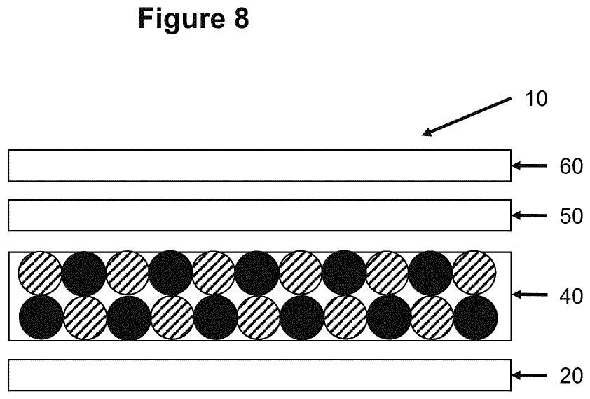

In certain embodiments, the gas-permeable adsorbent layer may further comprise activated carbon, either dispersed within the same nonwoven scaffold (See FIGS. 5 and 8) as the MOF material 46 or provided as a separate gas-permeable carbon layer 30 positioned adjacent to the gas permeably adsorbent layer 40. The MOF material 46 present in the gas-permeable adsorbent layer may comprise a single MOF species or a mixture of two or more distinct MOFs. In certain embodiments, the MOF material 46 comprises a zirconium-based MOF, which may be preferred for its structural stability and chemical resistance. In some embodiments, the zirconium-based MOF includes linker molecules bearing functional groups, including amino substituents, that enhance adsorption and/or degradation of airborne toxic chemical agents.

In certain embodiments, the total adsorbent loading within the gas-permeable adsorbent layer may range from about 50 grams per square meter (gsm) to about 500 gsm, including embodiments of about 100 gsm to about 400 gsm. Where MOF particles 46 are present, the MOF may constitute about 40 wt % to about 95 wt % of the total adsorbent content of the layer. Where activated carbon material 36 is present, the activated carbon material 36 may constitute about 40 wt % to about 95 wt % of the total adsorbent content of the layer. In embodiments comprising both MOF material 46 and activated carbon material 36 within the same layer, the relative proportions of MOF and activated carbon may be selected to achieve desired adsorption capacity, degradation performance, or service life characteristics.

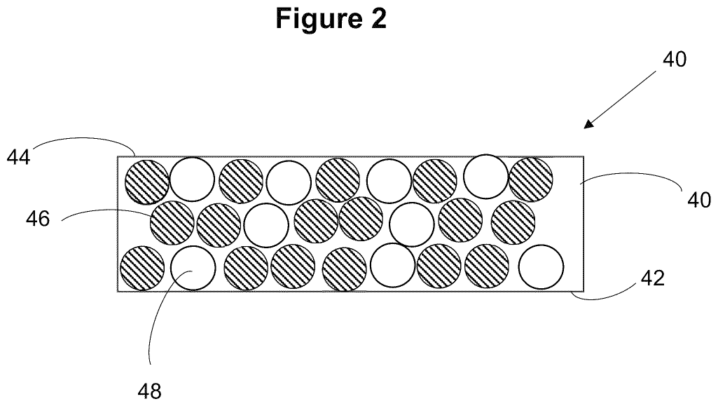

In certain embodiments, the particulate thermally activatable adhesive material 48 is present in the gas-permeable adsorbent layer 40 in an amount effective to immobilize the adsorbent particles 46 while preserving interstitial void volume and gas permeability. (See FIG. 2) By way of example, the adhesive particles may be present at about 1 wt % to about 40 wt % of the combined weight of the adhesive particles and adsorbent particles in the gas-permeable adsorbent layer 40, including embodiments of about 3 wt % to about 25 wt % or about 5 wt % to about 20 wt %. In certain embodiments, the adhesive particles are present at about 2 gsm to about 80 gsm, including embodiments of about 5 gsm to about 50 gsm, measured per unit area of the gas-permeable adsorbent layer 40. In certain embodiments, the adsorbent particles 46 and adhesive particles are provided at an adsorbent-to-adhesive weight ratio of about 1:1 to about 20:1, including embodiments of about 2:1 to about 10:1 or about 3:1 to about 6:1. The adhesive particles may comprise thermoplastic copolyester, copolyamide, thermoplastic polyurethane, polyamide, or polyolefin hot-melt materials supplied in granular or powder form, and may be dry blended with MOF granules and/or activated carbon granules prior to incorporation into the scaffold. Suitable materials include, for example, copolyester hot-melt adhesives such as Griltex® materials available from EMS-Griltech, Dynapol® copolyesters available from Evonik, and similar thermally activatable adhesive resins commercially available from Bostik or Henkel.

In certain embodiments, the adhesive particles exhibit a softening or activation temperature in a range of about 50° C. to about 200° C., more particularly about 70° C. to about 120° C. and may have an average particle size of about 20 μm to about 500 μm. Upon thermal activation during lamination, calendaring, or consolidation, the adhesive particles soften or melt and flow to at least partially bond to adjacent fibers of the scaffold and/or to adjacent adsorbent particles, thereby enhancing mechanical immobilization and structural integrity of the layer while maintaining interstitial void volume, gas permeability, and access to the adsorbent surface, and without fully encapsulating the adsorbent particles.

### Vapor-Permeable Layer

FIG. 1 illustrates a vapor-permeable layer 50 positioned adjacent to the gas-permeable adsorbent layer outer face 44. The vapor-permeable layer 50 has a vapor-permeable layer inner face 52 and an opposing vapor-permeable layer outer face 54. The vapor-permeable layer inner face 52 is disposed toward the gas-permeable adsorbent layer outer face 44. The vapor-permeable layer 50 may comprise a porous membrane or fabric configured to permit the passage of moisture vapor while limiting direct penetration by liquid droplets, aerosolized contaminants, or particulate matter. The vapor-permeable layer 50 may function as a dispersion and flow-distribution layer that spatially redistributes incoming airborne toxic chemical agents across a broader surface area prior to contact with the underlying gas-permeable adsorbent layer 40. By distributing and diffusing vapor-phase or aerosolized contaminants, the vapor-permeable layer 50 increases the effective flow path length through the multi-layer fabric construction 10 and enhances the probability of contact between contaminants and the underlying MOF and/or activated carbon materials.

The vapor-permeable layer 50 may comprise a microporous or monolithic polymer membrane, including but not limited to expanded polytetrafluoroethylene (ePTFE), expanded polyethylene (ePE), polyurethane (PU), polypropylene, or other breathable polymer membranes. In alternative embodiments, the vapor-permeable layer 50 may comprise a woven or nonwoven fabric produced by electrospinning, melt-blowing, spun-blowing, or other fibrous formation processes, provided that the layer maintains moisture vapor transmission while contributing to contaminant dispersion and mechanical integrity.

The vapor-permeable layer 50 may have a basis weight ranging from approximately 0.2 osy to about 2.0 osy (approximately 7 gsm to about 68 gsm), including embodiments of about 0.5 osy to about 1.0 osy (approximately 17 gsm to about 34 gsm). In certain embodiments, the vapor-permeable layer 50 has a thickness of about 20 microns to about 100 microns, including embodiments of about 25 microns to about 60 microns. The vapor-permeable layer 50 may exhibit a water vapor transmission rate (WVTR), measured according to ASTM E96 Procedure B, of at least about 500 gsm/24 hr, including embodiments of at least about 600 gsm/24 hr, 700 gsm/24 hr, or 750 gsm/24 hr. In certain embodiments, the vapor-permeable layer 50 may withstand hydrostatic pressures of at least about 6000 mm, including embodiments of at least about 7000 mm, 8000 mm, 9000 mm, or 10,000 mm. To maintain flexibility and wearer comfort, the vapor-permeable layer 50 may exhibit an elongation at break of at least about 100%, including embodiments of at least about 120% or at least about 150%, as measured in accordance with ASTM D5034.

### Outer Fabric Layer

FIG. 1 illustrates an embodiment with an outer fabric layer 60 disposed adjacent the vapor-permeable layer 50. The outer fabric layer inner face 62 faces the vapor-permeable layer outer face 54. An opposing outer fabric layer outer face 64 is oriented toward the external environment. The outer fabric layer 60 functions primarily as a protective and durability layer for the multi-layer fabric construction 10 and may also contribute to comfort, flexibility, and environmental resistance. In alternate embodiments the outer fabric layer 60 may be omitted.

The outer fabric layer 60 may comprise woven, knitted, nonwoven, or composite textile materials and may be stretch or non-stretch. Suitable materials include flame-resistant or non-flame-resistant fabrics, including aramid-based materials, cotton, nylon, polyester, polyolefins, polyamides, blends thereof (including cotton/nylon blends), and other textile constructions capable of withstanding environmental exposure and garment fabrication processes.

The outer fabric layer 60 may have a basis weight ranging from about 2.0 osy to about 7.5 osy (approximately 68 gsm to about 255 gsm), including embodiments of about 4.5 osy to about 6.0 osy (approximately 150 gsm to about 200 gsm), or about 150 gsm to about 250 gsm, including about 180 gsm to about 220 gsm.

Ther outer fabric layer outer face 64 is configured to face the ambient environment and may be directly exposed to sunlight, precipitation, liquid contaminants, vapor-phase toxic agents, aerosolized agents, and other environmental conditions encountered during use. The outer fabric layer 60 may optionally include a surface treatment or coating to enhance resistance to liquid penetration, staining, or contamination. Such treatments may include liquid-repellent coatings, durable water repellent (DWR) finishes, silica-based coatings, fluorinated or non-fluorinated hydrophobic treatments, or other surface modifications that do not materially impair vapor transmission through the underlying vapor-permeable layer 50.

In the present construction, the gas-permeable adsorbent layer 40 and any adjacent fabric layers remain functionally and structurally distinct layers within the multi-layer fabric construction 10. In some embodiments the multi-layer fabric construction 10 may be a laminate. The layered architecture is configured to be substantially free of intentional insulating air gaps between functional layers, thereby permitting heat and moisture vapor generated by the wearer to pass through the construction while maintaining adsorption and/or degradation performance against airborne toxic chemical agents. As a result, garments formed from the multi-layer fabric construction 10 may provide improved thermal comfort and extended wear duration while maintaining protective performance.

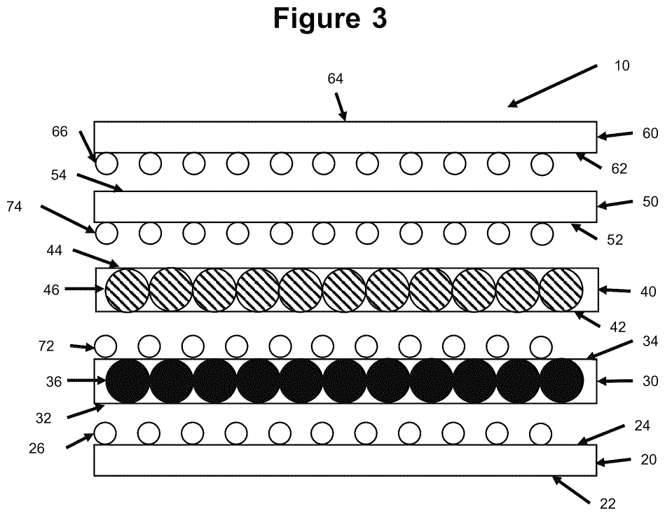

In the embodiment illustrated in FIG. 3, the optional inner fabric layer 20 can be secured to the gas-permeable carbon layer 30 with a first adhesive layer 26 disposed between the inner fabric layer outer face 24 and the gas-permeable carbon layer inner face 32. The adhesive layer 26 is preferably applied in a discontinuous, gas-permeable configuration to preserve breathability while providing mechanical integrity to the assembled structure.

The adhesive layer may comprise a thermal adhesive, a polymerizable adhesive, or a combination thereof. As used herein, a “thermal adhesive” refers to an adhesive that softens, melts, or flows upon application of heat to effect bonding between adjacent layers. A “polymerizable adhesive” refers to an adhesive that undergoes curing, crosslinking, or polymerization upon activation, including activation by heat, moisture, radiation, or chemical reaction. The adhesive may be provided in particulate, film, sheet, web, powder, or liquid form, provided that the bonded interface maintains gas permeability across the laminated structure.

In certain embodiments, the adhesive comprises a thermal adhesive activated during lamination.

The first adhesive layer 26 can comprise either a thermal adhesive or a polymerizable adhesive. Advantageously, use of a polymerizable adhesive will prevent shifting of the gas-permeable carbon layer 30 with respect to the inner fabric layer 20 in subsequent thermal processing steps. Suitable polymerizable adhesives include, without limitation, hot melt adhesives such as those based on polyurethane or polyolefin and available from Jowat Adhesives (doing business as Jowat Corporation, headquartered in High Point, North Carolina) or Henkel (doing business as Henkel North American Consumer Goods, headquartered in Stamford, Connecticut) or any adhesive that provides acceptable results.

The first adhesive layer 26 may be discontinuous to permit outward transmission of heat and moisture from a wearer of an article formed from the multi-layer fabric construction 10. The adhesive may be applied in a discontinuous pattern, including dot matrix, web, spray, gravure, reverse gravure, or patterned roller configurations, such that airflow and moisture vapor transmission are maintained. In certain embodiments, the adhesive layer may be applied at loadings sufficient to provide bonding while preserving gas permeability, including loadings of about 5 to about 50 gsm, depending on the interface and materials being joined. The adhesive may be applied to the outer face 24 of the inner fabric layer 20, to the inner face 32 of the gas-permeable carbon-containing layer 30, or to both. Bonding may be achieved by roll lamination, heat pressing, thermal fusion (including melting of a thermoplastic tie layer), ultrasonic bonding, pressure-assisted bonding, or combinations thereof. In certain embodiments, adjacent layers may be laminated sequentially or as a stacked assembly in a single consolidation step.

The gas-permeable carbon layer 30 can be secured to the gas-permeable adsorbent layer 40 with a second adhesive layer 72 disposed between the between the gas-permeable carbon layer outer face 34 and the gas-permeable adsorbent layer inner face 42. The gas-permeable adsorbent layer 40 can be secured to the vapor-permeable layer 50 with a third adhesive layer 74 disposed between the between the gas-permeable adsorbent layer outer face 44 and the vapor-permeable layer inner face 52. The second and third adhesive layers 72, 74 are preferably applied in a discontinuous, gas-permeable configuration to preserve breathability while providing mechanical integrity to the assembled structure.

The second and third adhesive layers 72, 74 can comprise a thermal adhesive or a polymerizable adhesive. In certain embodiments, the adhesive may comprise a thermally activatable polymer layer that softens or melts during lamination to form a bond between adjacent layers. The adhesive selection may be based on desired flexibility, durability, and environmental resistance of the multi-layer fabric construction. Polymerizable adhesives are preferred for their flexibility and resilience but any adhesive that has acceptable results may be used.

As illustrated in FIG. 3, the second adhesive layer 72 may be applied to the gas-permeable carbon layer outer face 34 as a discontinuous pattern such as spraying, or gravure printing with a patterned roller, wherein the pattern on the roller provides the desired pattern of adhesive on the fabric surface. For example, the second adhesive layer 72 may be applied as a matrix of small adhesive dots. In an alternate embodiment, molten adhesive is applied to a roller having a textured surface and rolled over the gas-permeable carbon layer outer face 34 to form the second adhesive layer. In alternate embodiments, the second adhesive layer 72 may be applied to the gas-permeable adsorbent layer inner face 42 or both the gas-permeable carbon layer outer face 34 and the gas-permeable adsorbent layer inner face 42. Similarly, the third adhesive layer 74 may be discontinuous, may be applied to either the vapor-permeable layer inner face 52 or to the gas-permeable adsorbent layer outer face 44 or both. The second and third adhesive layers 72, 74 may be applied at loadings sufficient to provide bonding while maintaining gas permeability, including loadings similar to those described for the first adhesive layer 26.

After the second and third adhesive layers 72, 74 are applied, the respective layers may be bonded by lamination. In certain embodiments, the gas-permeable carbon-containing layer 30 is first laminated to the gas-permeable adsorbent layer 40 to form a subassembly, and the resulting subassembly is subsequently laminated to the vapor-permeable layer 50. In other embodiments, the carbon-containing layer 30, the gas-permeable adsorbent layer 40, and the vapor-permeable layer 50 may be assembled in stacked configuration and laminated in a single consolidation step. Lamination may be performed by roll lamination, heat pressing, thermal activation, or combinations thereof, and the adhesive layers 72, 74 may be cured or activated during the lamination process. In alternate embodiments the gas permeably carbon layer 30 and the gas-permeable adsorbent layer 40 may be adhered without an adhesive layer. Rather the scaffold in each layer may be heated to bond and form a contiguous layer. Note the resulting contiguous layer would maintain the permeability that each layer 30, 40 had before it was bonded.

The outer fabric layer 60 can be secured to the vapor-permeable layer 50 with a fourth adhesive layer 66 disposed between the between the vapor-permeable layer outer face 54 and the outer fabric layer inner face 62. The fourth adhesive layer 66 may be applied to the outer fabric layer inner face 62, the vapor-permeable layer outer face 54 or both.

The fourth adhesive layer 66 is preferably a thermal adhesive or a polymerizable adhesive and the fourth adhesive layer 66 may be applied as a matrix of small adhesive dots. In an alternate embodiment, molten adhesive is applied to a roller having a textured surface and rolled. The fourth adhesive layer 66 may be discontinuous, Advantageously, use of a polymerizable adhesive will prevent shifting of the outer face fabric 60 with respect to the vapor-permeable layer 50 in subsequent thermal processing steps. Suitable polymerizable adhesives include the same adhesives used for adhesive layer 26. The adhesive layer 66 can be applied by methods such as spraying, or gravure printing with a patterned roller, wherein the pattern on the roller provides the desired pattern of adhesive on the fabric surface. The adhesive layer 66 may be applied to either the vapor-permeable layer outer face 54 or to the outer fabric layer inner face 62, or to both. The vapor-permeable layer 50 and the outer fabric layer 60 may be laminated, via roll lamination or heat pressing, and the adhesive is allowed to cure

Adhesive layers 66, 74, 72, 26 are preferably applied in a discontinuous, gas-permeable configuration to preserve breathability while providing mechanical integrity to the assembled structure. In particular, the gas-permeable adsorbent layer 40 is preferably secured to adjacent layers in a discontinuous, gas-permeable manner so as to preserve airflow through the multi-layer fabric construction 10. In certain embodiments, gas-permeable adhesive layers may be applied at loadings sufficient to provide bonding while preserving vapor transmission, including loadings of about 5 to about 50 gsm, depending on the interface and materials being joined.

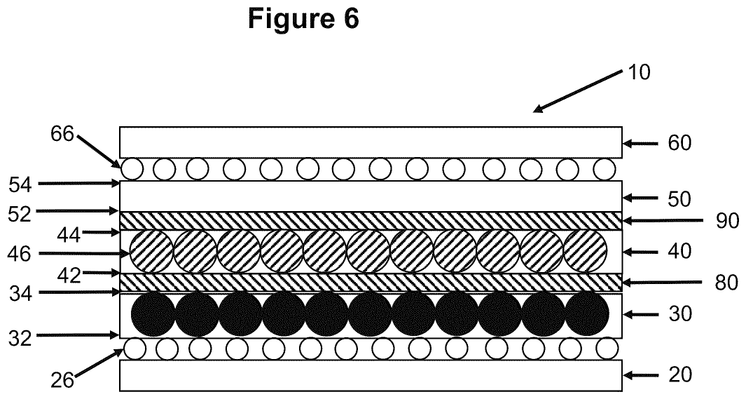

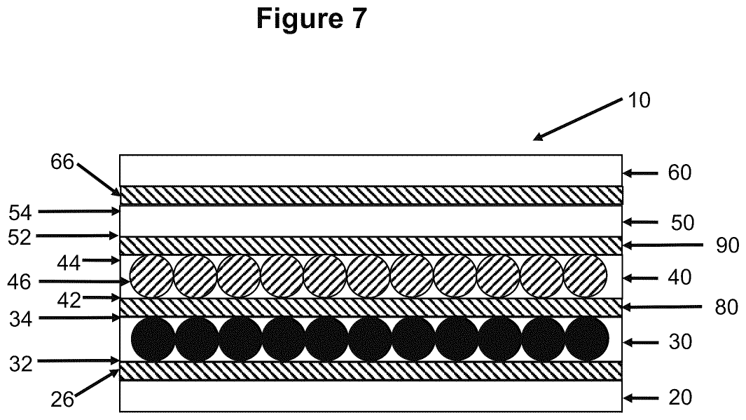

In an alternative embodiment illustrated in FIGS. 6 and 7, bonding between adjacent functional layers may be achieved using one or more gas-permeable adhesive layers. For example, the interface between the gas-permeable carbon layer 30 and the nonwoven adsorbent web layer 40 may include a gas-permeable adhesive layer 80. Similarly, the interface between the nonwoven adsorbent web layer 40 and the vapor-permeable layer 50 may include a gas-permeable adhesive layer 90. Adhesive layers 80 and 90 may comprise discontinuous adhesive films, patterned adhesive sheets, web adhesives, or other gas-permeable adhesive structures that maintain air and moisture vapor transmission through the construction. When adhesive sheets are used, separate adhesive application to the outer face 34 of gas-permeable carbon layer 30 or the inner face 52 of vapor-permeable layer 50 may be optional. In certain embodiments, the nonwoven adsorbent web layer 40 may function as an adsorbent-adhesive composite region, wherein adhesive layers and dispersed adsorbent particles are arranged in a layered or integrated configuration that maintains gas permeability and particle accessibility.

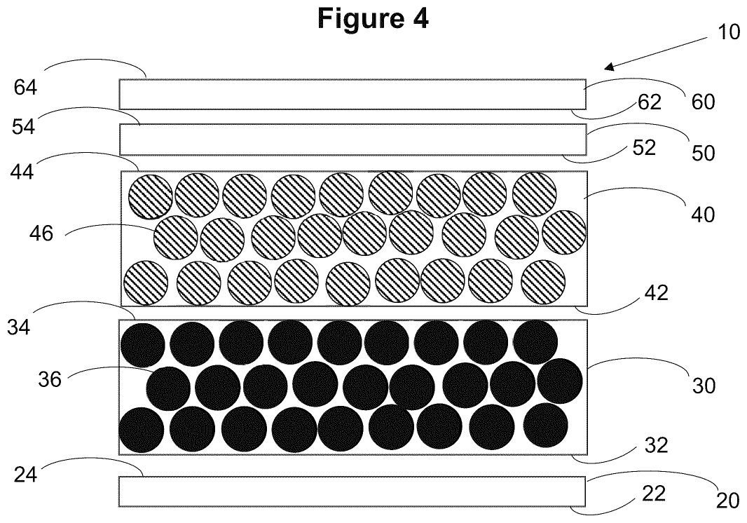

FIG. 4 illustrates a cross-sectional view of the embodiment of FIG. 1 in which both layer 30 and layer 40 are gas-permeable adsorbent layers. In the embodiment illustrated in FIG. 4, the gas-permeable carbon layer 30 may comprise activated carbon and the gas-permeable adsorbent layer 40 may comprise MOF material, although other combinations and arrangements are contemplated. The figure further illustrates that multiple gas-permeable adsorbent layers may be employed in series to enhance adsorption capacity, degradation performance, or both.

The gas-permeable adsorbent layer 40 may comprise a nonwoven web of entangled microfibers within which the MOF material 46 is distributed at various depths throughout the scaffold. The MOF material 46 may be surface-biased, depth-graded, or stratified within the thickness of the scaffold. By distributing the MOF material 46 in a three-dimensional arrangement rather than as a single planar layer, gas-phase toxic materials traversing the scaffold encounter an increased probability of contact with the adsorbent MOF material 46 along tortuous flow paths. In one embodiment illustrated in FIG. 4, the gas-permeably carbon layer 30 comprises a nonwoven scaffold of entangled organic polymeric microfibers within which a plurality of activated carbon particles 36 are dispersed and mechanically retained at various depths throughout the thickness of the scaffold. The carbon particles 36 may be uniformly or substantially uniformly distributed across the surface plane and/or stratified within the scaffold. Such a nonwoven scaffold containing activated carbon particles may be prepared using processes analogous to those described for incorporation of MOF material 46 into a nonwoven web.

FIG. 5 illustrates an embodiment of the multi-layer fabric construction 10 in which MOF material 46 and carbon material 36 are both interspersed in the gas-permeable adsorbent layer 40. In this embodiment the gas-permeable adsorbent layer 40 functions as a mixed-adsorbent scaffold containing both MOF material 46 and carbon material or particles 36 distributed within the fibrous network. With both MOF materials 46 and carbon material 36 present, the gas-permeable adsorbent layer 40 may be configured to chemically decompose at least a portion of the toxic chemical agents upon contact, in addition to provide broad-spectrum adsorption. The gas-permeable adsorbent layer 40 illustrated in FIG. 5 may optionally include carbon impregnated species that promote chemisorption or catalytic reactivity.

In the embodiment illustrated in FIG. 5, the gas-permeable adsorbent layer 40 is in between the inner face layer 20 and the vapor-permeable layer 50. An outer layer fabric is adjacent vapor-permeable layer 50.

In the embodiment illustrated in FIG. 8, the MOF particles 46 and carbon particles 36 are interspersed in the gas-permeable adsorbent layer 40 and various depths. While the illustration demonstrates an alternating position of MOF particles 46 and carbon particles 36, the actual number of MOF particles 46 and carbon particles 36 may not be equal and the relative positioning of MOF particles 46 and carbon particles 36 to each other may be varied. The placement and ratio of MOF particles 46 and carbon particles 36 may be application specific and variable as long as acceptable results are achieved.

In an alternative embodiment illustrated in FIGS. 6 and 7, bonding between adjacent functional layers may be achieved using one or more gas-permeable adhesive layers while maintaining gas permeability and multi-stage contaminant interaction.

As illustrated in FIGS. 6, the interface between the gas-permeable carbon layer 30 and the gas-permeable adsorbent MOF layer 40 may include a first gas-permeable adhesive layer 80. Similarly, the interface between the gas-permeable adsorbent layer 40 and the vapor-permeable layer 50 may include a second gas-permeable adhesive layer 90. Adhesive layers 80 and 90 may comprise discontinuous adhesive films, patterned adhesive sheets, web adhesives, or other gas-permeable adhesive structures that maintain air and moisture vapor transmission through the multi-layer fabric construction 10. When adhesive sheets are used, separate adhesive application to the gas-permeable carbon layer outer face 34 or the vapor-permeable layer inner face 52 may be optional. In certain embodiments, the gas-permeable adsorbent layer 40 may function as an adsorbent-adhesive composite region, wherein adhesive layers and dispersed adsorbent particles are arranged in a layered or integrated configuration that maintains gas permeability and particle accessibility.

In FIG. 7, a third adhesive layer 82 is disposed between the outer fabric layer inner face 62 and the vapor-permeable layer outer face 54. A fourth adhesive layer 92 is disposed between the inner fabric layer outer face 24 and the gas-permeable carbon layer inner face 32.

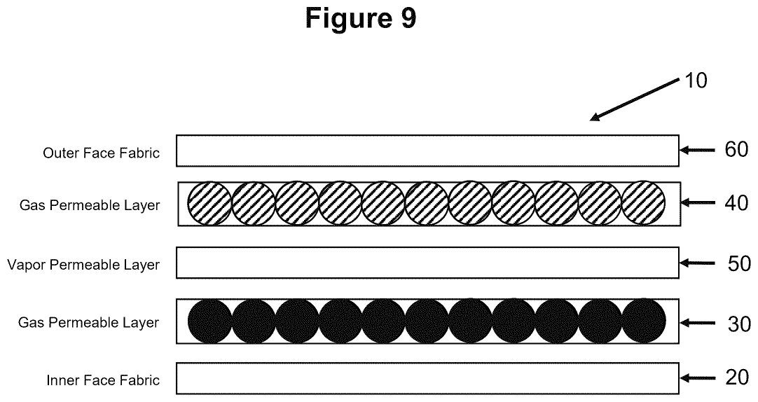

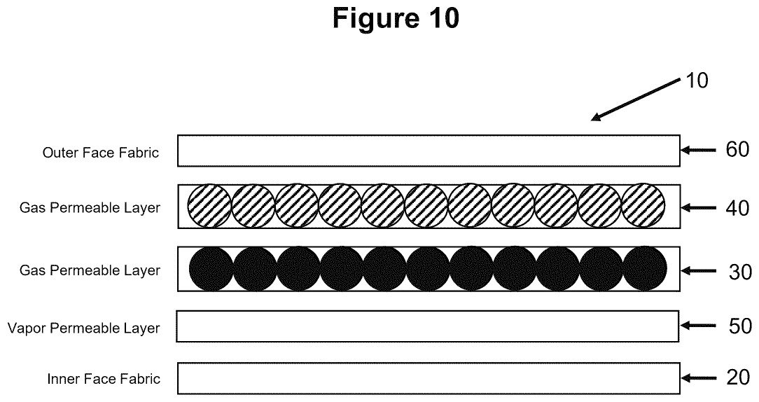

The alternate embodiments illustrated in FIGS. 9 and 10 employ different stratification orders or layer configurations while maintaining gas permeability and multi-stage contaminant interaction. FIG. 9 illustrates an embodiment in which the inner fabric layer 20 is adjacent the gas-permeable carbon layer 30. The vapor-permeable layer 50 is between the gas-permeable carbon layer 30 and the gas-permeable adsorbent layer 40. The outer fabric layer is adjacent the vapor-permeable layer 50.

FIG. 10 illustrates an embodiment in which the inner fabric layer 20 is adjacent the vapor-permeable layer 50. The gas-permeable carbon layer 30 is between the vapor-permeable layer 50 and the gas-permeable adsorbent layer 40. The outer fabric layer is adjacent the gas-permeable adsorbent layer 40.

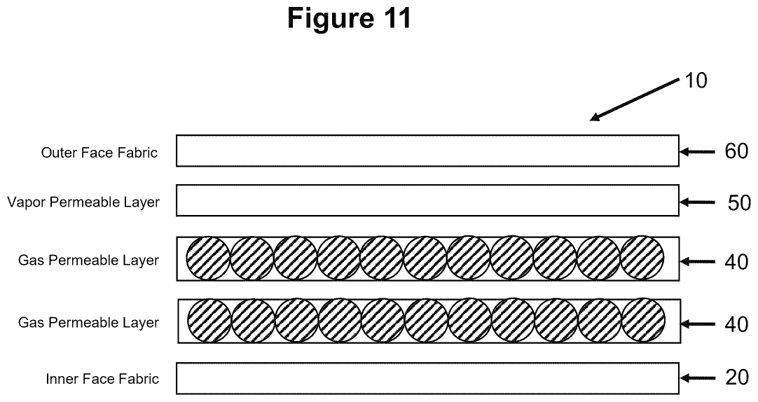

Other alternative embodiments, as illustrated in FIGS. 11-13 and 18, include configurations in which either MOF material 46 or activated carbon 36 is present as the sole adsorbent within a gas-permeable carbon layer 30 or gas-permeable adsorbent layer 40 of the multi-layer fabric construction 10. In such embodiments, airborne toxic chemical agents that traverse the vapor-permeable layer 50 encounter the single adsorbent system, which may provide adsorption, degradation, or a combination thereof, depending on the properties of the selected adsorbent material. The architecture of the construction permits substitution of one adsorbent system for another without materially altering the layered, gas-permeable structure described herein.

In the embodiment illustrated in FIG. 11 the sole adsorbent is MOF material 46 in two gas-permeable adsorbent layers 40. The gas-permeable adsorbent layers 40 are adjacent each other and disposed between the inner fabric layer 20 and the vapor-permeable layer 50.

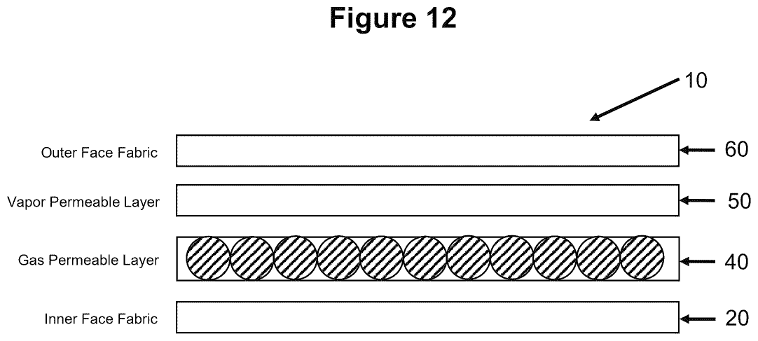

In the embodiment illustrated in FIG. 12 the sole adsorbent is MOF material 46 in a single gas-permeable adsorbent layer 40. The gas-permeable adsorbent layer 40 is disposed between the inner fabric layer 20 and the vapor-permeable layer 50. An outer fabric layer 60 is disposed adjacent the vapor-permeable layer 50.

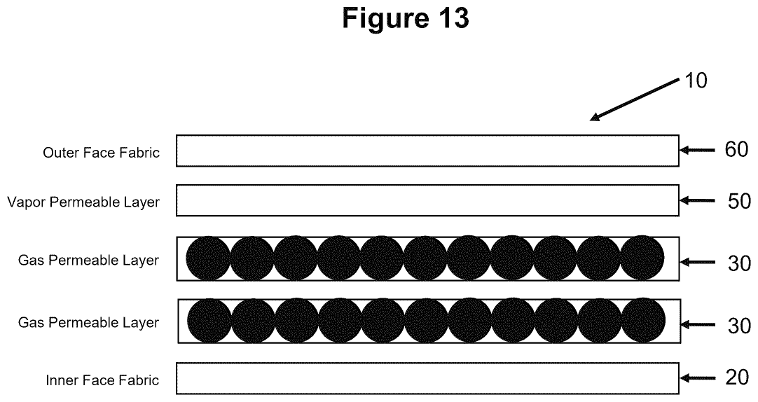

In the embodiment illustrated in FIG. 13 the sole adsorbent is carbon material 36 in two gas-permeable carbon layers 30. The two gas-permeable carbon layers 30 are adjacent to each other and disposed between the inner fabric layer 20 and the vapor-permeable layer 50. An outer fabric layer 60 is disposed adjacent the vapor-permeable layer 50.

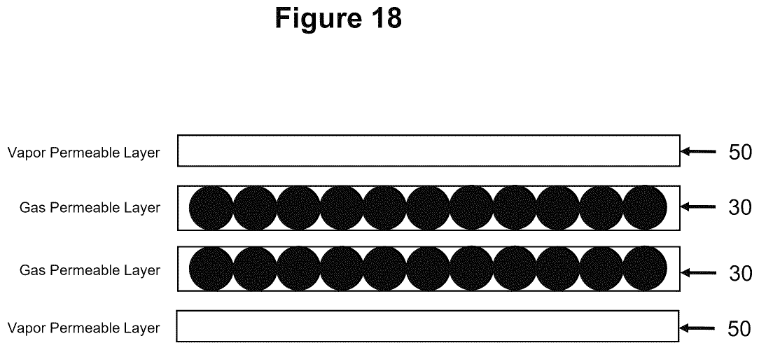

In the embodiment illustrated in FIG. 18 the sole adsorbent is carbon material 36 in two gas-permeable carbon layers 30. The two gas-permeable carbon layers 30 are adjacent to each other and disposed between two vapor-permeable layers 50. Note there is no outer fabric layer 60 illustrated in FIG. 18 yet alternate embodiments may have an outer fabric layer 60.

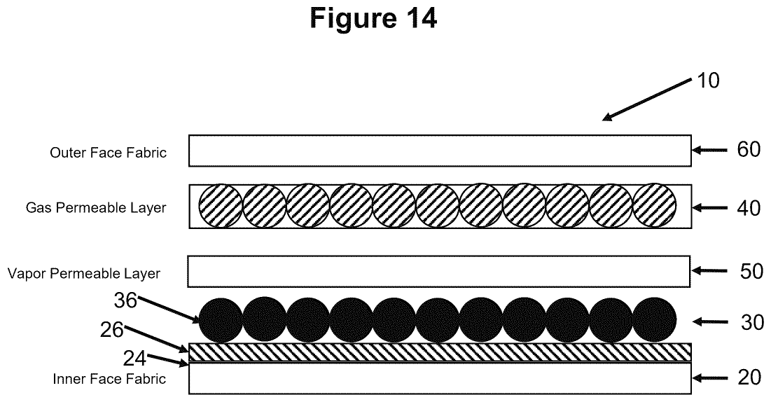

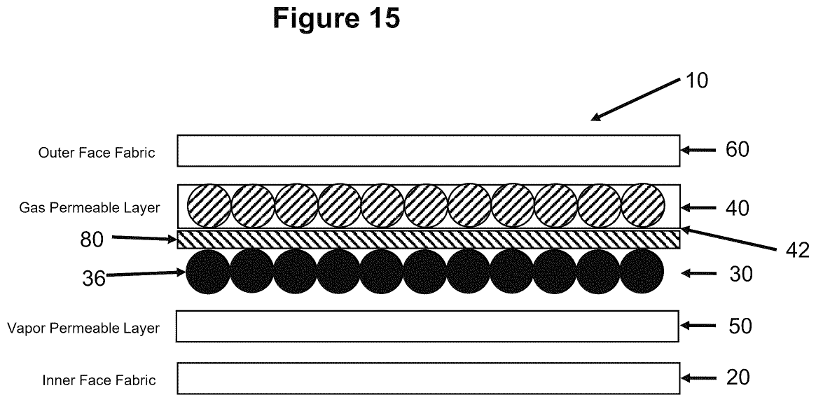

In alternative embodiments illustrated in FIGS. 14 and 15, the activated carbon material 36 may be positioned at or near an interface between layers. For example, in FIG. 14, the activated carbon material 36 may be applied to the inner fabric layer outer face 24 and secured by a gas-permeable adhesive layer 26.

In FIG. 15 the activated carbon material 36 may be applied to the gas-permeable adsorbent layer inner face 42 and secured by a gas-permeable adhesive layer 80. Alternate positioning may include any intervening layer within the construction that produces acceptable results. In such embodiments, the activated carbon material 36 may be partially embedded into an adjacent layer to enhance mechanical anchoring while preserving exposure of the activated carbon material 36 to gas flow.

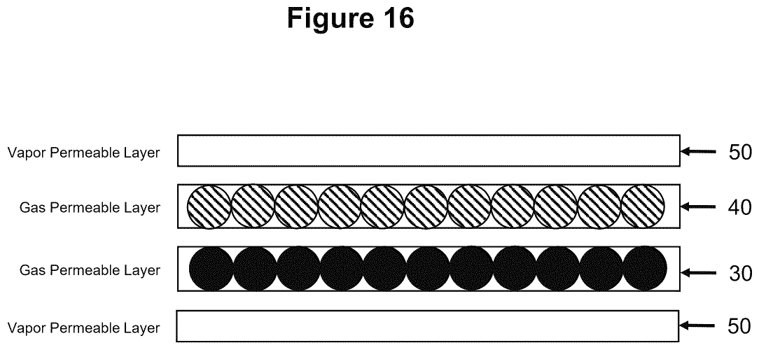

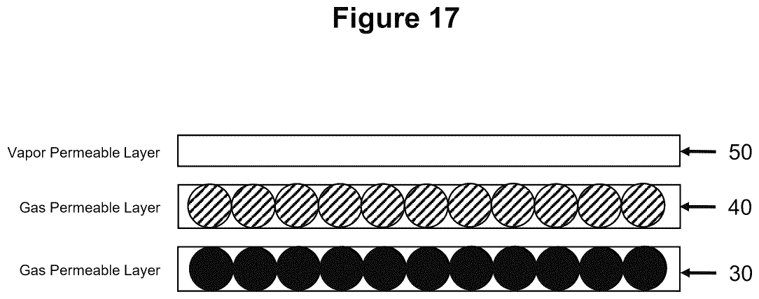

In certain embodiments illustrated in FIGS. 16-18, the multi-layer fabric construction 10 may include the functional vapor-permeable layer 50 and gas-permeable carbon layer 30 and/or gas-permeably adsorbent layer 40 without the optional inner fabric layer 20 or outer fabric layer 60. For example, the embodiment of FIG. 16 includes a first vapor-permeable layer 50, a second vapor-permeable layer 50, and one or more gas-permeable adsorbent layers 30, 40 arranged therebetween. As in the previously described embodiments, adjacent layers are positioned in direct or substantially direct contact and the construction is substantially free of intentional insulating air gaps between functional layers. Gas-permeable adhesives or other discontinuous bonding structures may be used to secure the layers while preserving airflow and moisture vapor transmission. FIGS. 17 and 18 illustrate additional intermediate configurations employing different combinations and sequences of vapor-permeable and gas-permeable adsorbent layers. FIG. 17 illustrates a gas permeably carbon layer 30 as the innermost layer. A gas-permeable adsorbent layer is adjacent the gas permeably carbon layer 30 and a vapor permeably layer 50. The vapor permeably layer 50 is the outermost layer.

FIG. 18 illustrates two gas permeable carbon layers 30 disposed between two vapor permeably layers 50. The vapor permeably layers 50 are the innermost and outermost layers.

In the various embodiments disclosed herein, airborne toxic chemical agents will first encounter either the optional outer fabric layer 60 or, in embodiments lacking an outer fabric layer, the vapor-permeable layer 50. The outer fabric layer 60, when present, may provide partial liquid repellency or environmental resistance but does not serve as the primary adsorbent layer. Upon reaching the vapor-permeable layer 50, vapor-phase or aerosolized contaminants may be spatially redistributed and dispersed across a broader surface area before contacting the underlying gas-permeable adsorbent layer 40. Larger droplets may spread or fragment into smaller droplets as they interact with the vapor-permeable layer, increasing effective surface area and contact probability. As a result, contaminant molecules traverse an extended and more tortuous path before reaching the adsorbent particles within the nonwoven scaffold in the gas permeably adsorbent layer 40, thereby increasing the likelihood of adsorption and/or degradation within the gas-permeable adsorbent layer 40.

As airborne toxic chemical agents contact the gas-permeable adsorbent layers 30 and 40, the agents may be adsorbed and/or chemically degraded by the MOF material and/or the activated carbon present within at least the gas permeably carbon layer 30. The construction permits multiple architectural permutations of the gas-permeable adsorbent layers 30 and 40 and the adsorbents contained therein. For example, in the embodiment illustrated in FIGS. 1, 3 and 4, separate and distinct gas-permeable adsorbent layers 30 and 40 form a bi-layer configuration, with one layer comprising MOF particles and the other comprising activated carbon. In such embodiments, contaminant molecules that are not captured or degraded in a first adsorbent layer may subsequently encounter and be captured in the second adsorbent layer.

In embodiments employing MOF material capable of catalytic or reactive degradation, at least a portion of the toxic chemical agents may be decomposed or chemically transformed upon contact with the MOF. Reaction products and residual species may then be adsorbed by the same layer or by an adjacent gas-permeable carbon-containing layer. This multi-stage adsorption and/or degradation mechanism can reduce the concentration of active toxic agents within the construction.

Alternative embodiments may employ different stratification orders or layer configurations while maintaining gas permeability and multi-stage contaminant interaction.

Other alternative embodiments, as illustrated in FIGS. 11-13 and 18, include configurations in which either MOF material or activated carbon is present as the sole adsorbent within a gas-permeable carbon layer 30 or 40 of the multi-layer fabric construction 10. In such embodiments, airborne toxic chemical agents that traverse the vapor-permeable layer 50 encounter the single adsorbent system, which may provide adsorption, degradation, or a combination thereof, depending on the properties of the selected adsorbent material. The architecture of the construction permits substitution of one adsorbent system for another without materially altering the layered, gas-permeable structure described herein.

In a further embodiment, a multi-layer fabric construction 10 comprises at least one vapor-permeable layer and at least one gas-permeable adsorbent layer comprising a porous, three-dimensional scaffold of entangled polymeric microfibers. The scaffold mechanically retains a plurality of adsorbent particles selected from MOF particles, activated carbon particles, or combinations thereof. The adsorbent particles may be distributed within the scaffold at multiple depths, including surface-biased, stratified, or depth-graded arrangements, while maintaining gas permeability through the layer.

In certain embodiments illustrated in FIGS. 16-18, the multi-layer fabric construction 10 may include the functional vapor-permeable and gas-permeable adsorbent layers without the optional inner or outer face fabrics. For example, the embodiment of FIG. 16 includes a first vapor-permeable layer, a second vapor-permeable layer, and one or more gas-permeable adsorbent layers arranged therebetween. As in the previously described embodiments, adjacent layers are positioned in direct or substantially direct contact and the construction is substantially free of intentional insulating air gaps between functional layers. Gas-permeable adhesives or other discontinuous bonding structures may be used to secure the layers while preserving airflow and moisture vapor transmission. FIGS. 17 and 18 illustrate additional intermediate configurations employing different combinations and sequences of vapor-permeable and gas-permeable adsorbent layers.

### Fabrication of the Nonwoven Adsorbent Layer

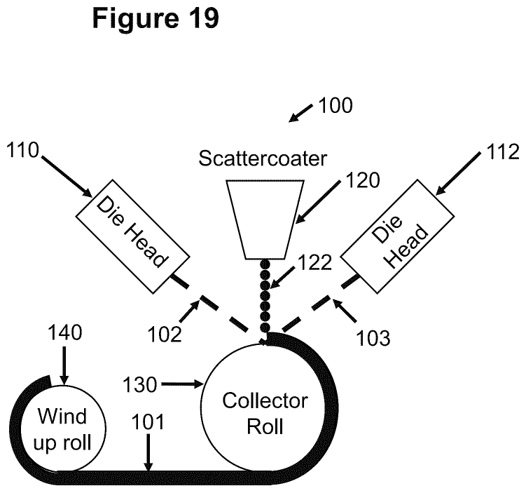

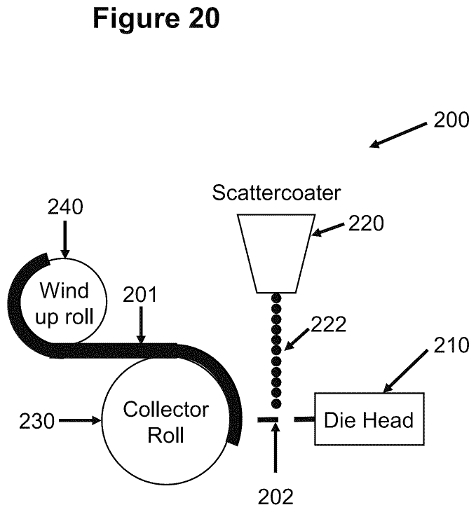

FIGS. 19 and 20 illustrate two configurations of a mechanical apparatus 100 and 200 used to produce a hybrid gas-permeable nonwoven scaffold 101, 201 as described above. In both mechanical configurations, a porous, three-dimensional microfiber network is formed by generating one or more fiber streams 102, 202 using a fiber-forming process. Suitable fiber-forming processes include melt-blowing, spun-blowing, electrospinning, solution blowing, extrusion, or combinations thereof. Fiber-forming process variables, including polymer throughput, air flow, air temperature, die pressure, humidity, and collector speed, may be adjusted to control fiber diameter, basis weight, thickness, porosity, and entanglement characteristics of the resulting nonwoven scaffold 101.

In mechanical apparatus 100, as illustrated in FIG. 19, fiber streams 102, 103 are produced from one or more die heads 110, 112 and directed toward a collector roll 130, where the fibers accumulate to form a lofted, entangled nonwoven scaffold 101. Fiber deposition parameters and collector speed are configurable to establish the desired scaffold 101 thickness and basis weight prior to and during particle incorporation.

Adsorbent particles 122, which may comprise MOF particles, activated carbon particles, or combinations thereof, are introduced from a controlled hopper or scatter-coating device 120 toward the forming scaffold 101. In apparatus 100, the particles 122 are deposited onto the collector roll 130 in a region between converging fiber streams so that ongoing fiber deposition mechanically captures and retains the particles 122 within the developing scaffold 101. Particle feed rate, fiber deposition rate, and collector speed may be coordinated to control particle loading and depth distribution within the scaffold 101, including surface-biased, stratified, or multi-depth configurations. In certain embodiments, the resulting adsorbent layer may comprise approximately 80 wt % to approximately 95 wt % adsorbent particles relative to total layer weight.

The formed hybrid nonwoven scaffold 101, comprising a porous, three-dimensional network of entangled microfibers and a plurality of adsorbent particles mechanically retained within interstitial voids throughout the thickness of the web, is subsequently conveyed to wind-up rolls 140. The take-up speed may be controlled to maintain substantially uniform basis weight, thickness, porosity, and particle distribution across the width and length of the web.

Apparatus 200, illustrated in FIG. 20, differs from apparatus 100 primarily in the location at which adsorbent particles 222 are introduced. In apparatus 200, fiber streams 202 generated from one or more die heads 210 are directed toward collector roll 230. Adsorbent particles 222 which may comprise MOF particles, activated carbon particles, or combinations thereof, are introduced from a controlled hopper 220 directly into the fiber stream 202 prior to deposition on the collector roll 230. The particles 222 become entrained within the fiber stream 202 and are subsequently retained within the forming scaffold 201 as the fibers accumulate. As in apparatus 100, process variables may be adjusted to achieve the desired particle loading, spatial distribution, and scaffold thickness.

The formed hybrid nonwoven scaffold 201, comprising a porous, three-dimensional network of entangled microfibers and a plurality of adsorbent particles mechanically retained within interstitial voids throughout the thickness of the web, is subsequently conveyed to wind-up rolls 240. Collector speed and take-up speed may be coordinated with fiber throughput and particle feed rate to ensure uniformity of basis weight, thickness, and particle incorporation.

During fiber formation using either apparatus 100 or apparatus 200, the fibers may comprise one or more thermoplastic polymers, elastomers, copolymers, polymer blends, or composite fibers selected to provide desired mechanical properties, including tensile strength, flexibility, compressive resilience, and recovery after deformation. Representative polymers include polyolefins such as polypropylene and polyethylene, polyesters, polyamides, polyether block amides (including polyether block amide elastomers), polyurethanes, and other elastomeric or block copolymer materials. Polymer blends and multi-component fibers are also contemplated, provided that the resulting scaffold maintains gas permeability and mechanical integrity.

### Method of Assembly

In one embodiment, a method of manufacturing a multi-layer fabric construction 10 comprises: (a) providing a gas-permeable adsorbent layer 40 comprising a porous, three-dimensional scaffold of entangled polymeric microfibers and a plurality of adsorbent particles selected from MOF particles 46, activated carbon particles 36, or combinations thereof mechanically retained within the scaffold at one or more depths; (b) providing a second subassembly comprising a vapor-permeable layer 50 and, optionally, an outer fabric layer 60 secured thereto; and (c) securing the gas-permeable adsorbent layer 40 to the second subassembly to form at least a portion of the multi-layer fabric construction 10.

In certain embodiments, the gas-permeable adsorbent layer 40 may itself be part of a first subassembly further comprising a gas-permeable carbon-layer 30, an optional inner fabric layer 20, or both, wherein the gas-permeable carbon-layer 30 may be disposed between the inner fabric layer 20 and the gas-permeable nonwoven adsorbent layer 40. The relative ordering of the gas-permeable carbon-layer 30 and the gas-permeable adsorbent layer 40 may be selected based on desired adsorption and/or degradation sequencing. Similarly, the number of gas-permeable carbon layers 30 and gas-permeable adsorbent layers 40 may be optimized in alternate embodiments based on desired adsorption and/or degradation sequencing

The subassemblies may be secured together by lamination using one or more gas-permeable adhesive layers as outlined above. The adhesive may be applied as a discontinuous pattern, including dot matrix, web, gravure, reverse gravure, spray, nanofiber, or sheet adhesive configurations, provided that gas and moisture vapor transmission through the construction is maintained. Lamination may be performed by roll lamination, heat pressing, ultrasonic bonding, or combinations thereof. In preferred embodiments, adjacent functional layers are brought into direct or substantially direct contact such that intentional insulating air gaps between layers are eliminated or substantially eliminated, thereby promoting thermal transfer and moisture vapor transport across the construction.

In an alternative embodiment, the method comprises: (a) providing a first subassembly comprising a gas-permeable carbon-layer 30 having a gas-permeable carbon-layer inner face 32 and a gas-permeable carbon-layer outer face 34, optionally including a gas-permeable adhesive layer 72 disposed on one face thereof; (b) providing a second subassembly comprising a vapor-permeable layer 50 and, optionally, an outer fabric layer 60 secured thereto; (c) providing a gas-permeable adsorbent layer 40 comprising a porous microfiber scaffold with MOF particles 46 mechanically retained therein; and (d) securing the first subassembly, the second subassembly, and the gas-permeable adsorbent layer 40 together such that the gas-permeable adsorbent layer 40 is positioned between the first and second subassemblies. The number of gas-permeable adsorbent layers 40, gas-permeable carbon layers 30 and the specific locations and layering of both may be optimized in alternate embodiments based on desired adsorption and/or degradation sequencing

In the foregoing methods, the gas-permeable carbon-layer 30 may comprise activated carbon 36 in particulate form, including beads or granules, or may comprise a nonwoven scaffold containing activated carbon particles mechanically retained within entangled polymeric microfibers.

In certain embodiments, one or more of the gas-permeable adhesive layers used in the construction may be provided as gas-permeable adhesive sheets. The adhesive sheets may be positioned at selected interfaces between adjacent functional layers while preserving airflow and moisture vapor transmission through the laminated structure.

### Metal Organic Frameworks

MOFs are the coordination product of metal ions and at least bidentate organic ligands. MOFs are made up of corner metal units comprising metal ion atoms and linker, i.e. ligand, molecules which form a framework having high surface area and uniformly sized pores, or pores of different pre-determined sizes. While it is known to use metal oxides in multi-layer fabric constructions, the use of MOFs having much higher surface areas offer greater adsorbency and greater decontamination capacity per unit area of the fabric construction.

Representative metals (M) which can be used to prepare MOFs include but are not limited to Zr, V, Al, Fe, Cr, Ti, Hf, Cu, Zn, Ni, Hf, In, Ce, and combinations thereof. For use in the multi-layer fabric constructions 10 disclosed herein, it is preferred to use MOFs having corner metal units comprising a metal that adsorbs or is otherwise reactive with an airborne toxic chemical agent of interest. A preferred set or subset of the above metals includes but is not limited to Zr, Al, Fe, Cu, or Zn and combinations thereof, with Zr and Fe being particularly preferred. Zr and Fe MOFs frameworks are also known to be stable under the operating conditions of relevant garments in particular high RH.

The organic ligands which react with the metal ions to form the framework structure preferably include at least one organic ligand which contains an aryl amino group or a combination of at least one organic ligand which contains an aryl amino group and at least one organic ligand which does not contain an amino group. Examples of organic ligands containing an aryl amino group include but are not limited to 2-aminobenzene-1,4 dicarboxylic acid (NH2-BDC), 5-aminoisophthalic acid, 3-aminobenzoic acid, 4-aminobenzoic acid and mixtures thereof. Examples of organic ligands which do not contain an aryl amino group include but are not limited to terephthalic acid (BDC), isophthalic acid, benzoic acid, trimesic acid, acrylic acid, and mixtures thereof. When the ligand is a combination of at least one organic ligand containing an aryl amino group and at least one organic ligand which does not contain an amino group, the molar ratio of amino containing: non-amino containing ligand varies from about 1:99 to about 99:1; or from about 10:90 to about 90:10; or from about 20:80 to about 80:20; or from about 30:70 to about 70:30; or from about 40:60 to about 60:40; or about 50:50. The amino function also can be added to the MOF by post synthesis methods.

The MOFs to be used in the multi-layer fabric construction 10 as disclosed herein may also comprise an inorganic metal (M′) salt which is impregnated onto the surface of the MOF or in the pores of the MOF. The M′ metal includes but is not limited to Li, Na, K, Mg, Ca, Sr, Ba, Mn, Sc, Y, Ti, Zr, Hf, V, Cr, Mo, W, Fe, Co, Ni, Cu, Ag, Zn, Cd, Al, Ga, In, Sn, Pb, and mixtures thereof. The M and M′ metals can be the same or different. It is preferred that the M′ metal be different from the M metal. The amount of metal salt impregnated on the MOF can vary considerably but is usually from about 1 wt % to about 70 wt. %; or from about 5 wt. % to about 65 wt. %; or from about 10 wt. % to about 60 wt. %; or from about 15 wt. % to about 55 wt. %; or from about 20 wt. % to about 50 wt. %; or from about 25 wt. % to about 45 wt. % as the metal. The inorganic M′ salt can be an anhydrous or hydrated salt selected from a halide, sulfate, carbonate, nitrate, or mixtures thereof. In one embodiment the M′ salt is a hydrous or anhydrous halide salt.

In one embodiment, the metal-impregnated MOFs may have a static ammonia capacity measured at 10 Torr and 25° C. of at least 4 mmol/g, or at least 5 mmol/g, or at least 6 mmol/g, or at least 8 mmol/g, or at least 10, mmol/g or at least 15, mmol/g or at least 20 mmol/g. In one embodiment the metal-impregnated MOF substantially retains its capacity for acidic TICs relative to the non-impregnated MOF. Particularly, it retains about 80% of its adsorption capacity for at least one acidic TIC.

In one embodiment the MOFs have a Brunauer-Emmett-Teller (BET) surface area of at least 1,000, or at least 1,100 m²/g, or at least 1,200 m²/g, or at least 1,300 m²/g, or at least 1,400 m²/g.

The MOFs may be synthesized by known methods. MOFs and impregnated MOFs suitable for use in the multi-layer fabric constructions and methods of their preparation include those disclosed in U.S. Patent Publication 2021/0379560 A1 and U.S. Patent Publication No. 2021/0379559 A1, the disclosures of which are incorporated herein by reference in their entireties.

The metal compound that is the source of the metal M and the one or more ligands are mixed in a solvent or a mixture of solvents.

Optionally an acid can be present in the reaction mixture during the MOF synthesis. In one embodiment the acid present during the MOF synthesis comprises a mono-carboxylic acid. such as formic acid, acetic acid, benzoic acid, dichloroacetic acid, trifluoroacetic acid and mixtures thereof. In one embodiment the acid present during the MOF synthesis further comprises an inorganic acid such as hydrochloric acid, nitric acid, or sulfuric acid, or mixtures thereof. In one embodiment the acid present during the MOF synthesis comprises a mixture of a mono-carboxylic acid and an inorganic acid.

The reaction mixture is reacted at a temperature and time to form the desired MOF. Reaction temperature can vary from about 50° C. to about 200° C. and for a time selected from about 1 hr. to about 78 hrs. The resulting MOF powder is isolated by filtration, centrifugation, etc. In some embodiments, the isolated MOF can be washed with an acid composition comprising an inorganic acid, or a mixture of one or more inorganic acids and one or more organic acids. Preferred inorganic acids include hydrochloric acid, nitric acid, and sulfuric acid. Preferred organic acids include formic acid.

In certain embodiments, the MOF material may be impregnated with one or more inorganic or organometallic species, including metal salts that serve as sources of a secondary metal (M′). Impregnation may be carried out by contacting the MOF with a solution, suspension, or dispersion comprising the selected metal salt under conditions sufficient to incorporate the metal species within or on the MOF structure. Representative metal salts include, without limitation, chlorides, nitrates, sulfates, carbonates, or other salts of magnesium, nickel, manganese, zinc, or mixtures thereof. Non-limiting examples include NiCl₂·6H₂O, MgCl₂ (anhydrous), MnCl₂·4H₂O, ZnCl₂ (anhydrous), and hydrated forms thereof.

The impregnated or non-impregnated MOF material may be used in powder form or formed into composite shaped bodies, including granules, beads, pellets, extrudates, or other structured forms. Where shaping is employed, the MOF powder may be combined with one or more binders to impart mechanical integrity while maintaining gas accessibility to the MOF surface and internal porosity. The impregnation step may be performed prior to shaping, during incorporation of the binder, or after formation of the shaped body, depending on the desired distribution of the impregnating species.

Examples of suitable inorganic binders, but not limited to, include clays (e.g., kaolin, attapulgite), aluminas, silicas, boehmite, metal oxides, and mixtures thereof. Examples of suitable organic binders, but not limited to, include polymers and natural polymers such as polyvinylpyrrolidone (PVP), polyethylene glycol, starch, gelatin, cellulose and cellulose derivatives, sucrose, chitosan, and mixtures thereof. The binder content may be selected to balance mechanical stability and preservation of adsorptive performance.

The MOF material used in the multi-layer fabric construction 10 described herein may comprise one or more MOFs, optionally impregnated as described above, and may further include binders, secondary adsorbents, catalytic species, or other functional additives. In certain embodiments, the MOF component constitutes at least about 50 wt %, at least about 60 wt %, at least about 70 wt %, at least about 80 wt %, at least about 90 wt %, or at least about 95 wt % of the total MOF material composition.

### Manufactured Articles

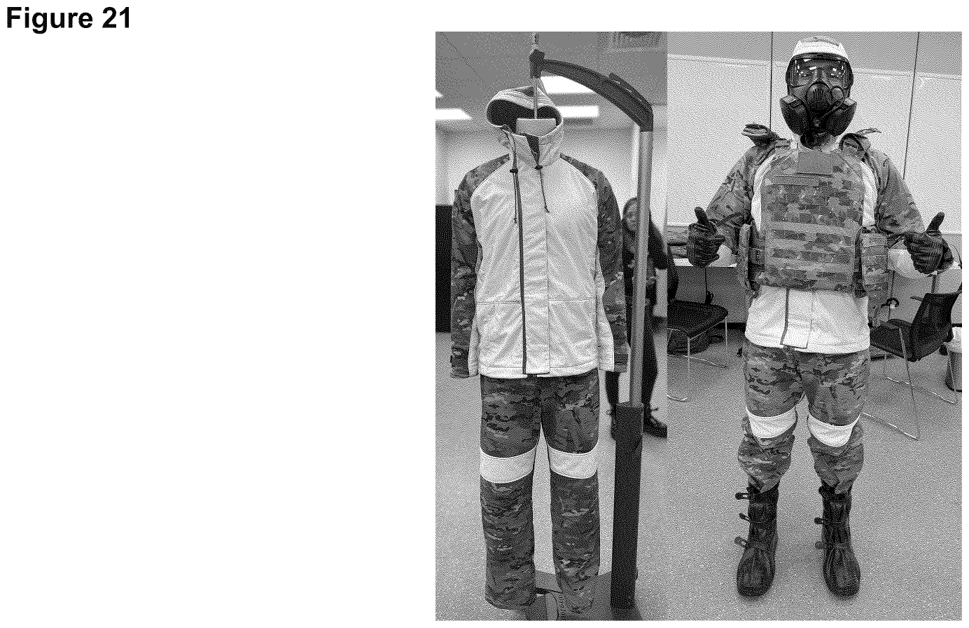

Embodiments of protective garments that include multi-layer fabric construction 10 of the present disclosure may include one piece or multi-piece (e.g., two-piece) garments, an example of which is found in FIG. 21. Such protective garments can be configured to cover a substantial portion of the wearer including the head, neck, torso, arms and legs. Such protective garments can also be configured to cover the hands and feet through the use of gloves and boots, respectively, that can include multi-layer fabric construction 10 of the present disclosure and be separate or integral to the protective garment.

The multi-layer fabric construction 10 as disclosed herein also can be used to construct other articles to provide protection against hazardous airborne contaminants. For example, the multi-layer fabric construction 10 as disclosed herein can be used in the construction of air filters, or protective packaging, or protective structures such as tents or parts thereof, or to provide protective articles for buildings or vehicles.

In one embodiment, the multi-layer fabric construction 10 achieves all goals set out by the NFPA-2025 Class III Standard.

In one embodiment, a swatch of the multi-layer fabric construction 10 has an evaporative resistance less than about 30 Pa-m²/W.

In one embodiment, a swatch of the multi-layer fabric construction 10 has a total heat loss test greater than or equal to about 200 W/m².

In one embodiment, a swatch of the multi-layer fabric construction 10 achieves NFPA protection challenges against TICs including ammonia (anhydrous), chlorine, and acrylonitrile at 15-minute and 60-minute time points under challenge conditions of vapor 40 ppm+/−10 ppm, 90° F.+/−2° F., 80% RH+/−5% RH, and dual flow.

In one embodiment, a swatch of the multi-layer fabric construction 10 achieves NFPA protection challenges against CWAs including HD, GD, and DMS at various time points (e.g., HD at 1 hr. and 24 hr.; GD at 1 hr. and 24 hr.; and DMS at 6 hr.) under challenge conditions of 10 gsm, 90° F.+/−2° F., 80% RH+/−5% RH, and dual flow.

In one embodiment, a swatch of the multi-layer fabric construction 10 achieves over 90% decontamination rate of CWAs including HD, GD, and DMS at various time points (e.g., HD at 1 hr. and 24 hr.; GD at 1 hr. and 24 hr.; and DMS at 6 hr.) under challenge conditions of 10 gsm, 90° F.+/−2° F., 80% RH+/−5% RH, and dual flow.

In one embodiment, the multi-layer fabric construction 10 has a GD permeation value of less than 1.2 μg/cm² and a HD permeation value of less than 4 μg/cm² as measured by TOP 8-2-501A when challenged at 5 grams/m² or 10 grams/m².

In one embodiment, we expect the multi-layer fabric construction 10 to have a water vapor transmission rate of at least 650 gsm/24 h as measured by ASTM E 96 Method B.

In one embodiment, we expect the multi-layer fabric construction 10 to have an air permeability of at least 0.50 cubic feet per minute (CFM) as measured by ASTM D 737, Air Permeability of Textile Fabrics.

In one embodiment, we expect the multi-layer fabric construction 10 to have a thermal resistance of less than 0.40 clo units as measured by the sweating guarded hot plate (SGHP) test of ASTM F1868 procedure Part C (Dry).

### EXAMPLES

### Samples

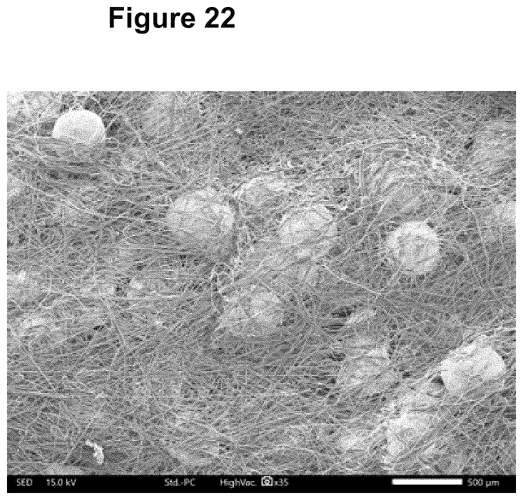

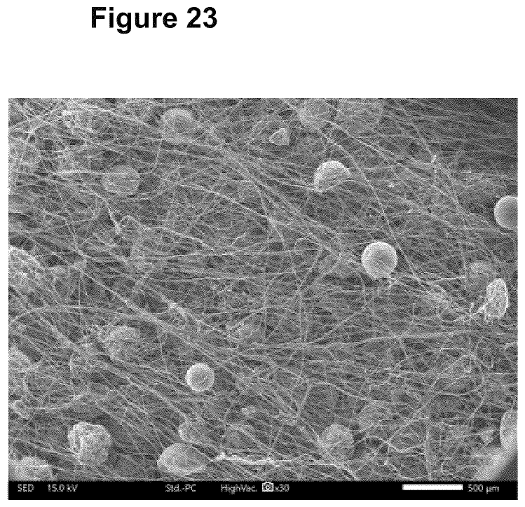

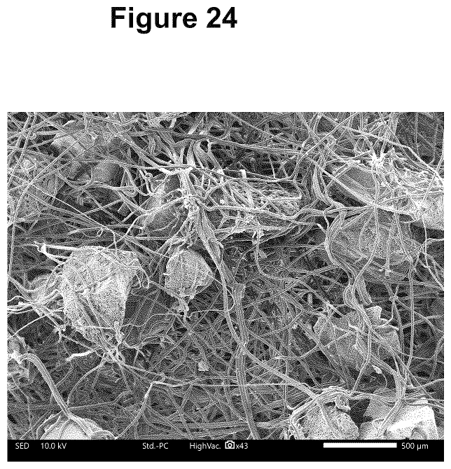

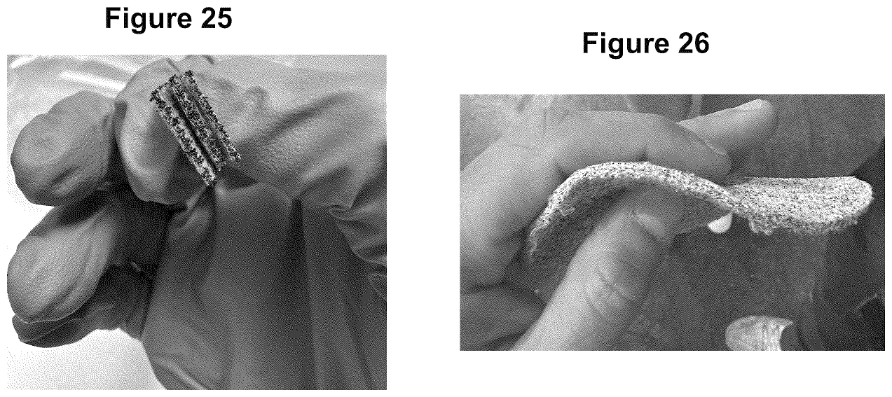

Various embodiments of the multi-layer fabric construction 10 were prepared and evaluated. Each construction comprised multiple functional layers laminated together, including a gas-permeable adsorbent layer formed as a nonwoven scaffold of entangled polymeric microfibers produced by a melt-blown process as illustrated in FIGS. 25 and 26. The adsorbent material and activated carbon material were mechanically retained within the scaffold as illustrated in FIGS. 22-24. In each sample, the vapor-permeable layer 50 comprised a porous membrane. Adjacent layers were bonded using adhesive applied in a discontinuous, gas-permeable pattern to maintain moisture vapor transmission and overall breathability of the laminate.

A knit or woven fabric was used as the outer face fabric. The MOF material was incorporated into the melt-blown nonwoven scaffold at loadings of about 65 to about 191 gsm, measured as active MOF content per unit area of the gas-permeable adsorbent layer. MOF granules were dry blended with granules of a thermally activatable co-polyester adhesive at a MOF-to-adhesive weight ratio of about 3:1 to about 5:1 prior to thermal consolidation within the scaffold. When present, the carbon-containing layer comprised activated carbon incorporated into a gas-permeable nonwoven structure and had a basis weight of about 120 to about 274 gsm.

Each of the samples set forth in Table 1 represents a multi-layer fabric construction 10 prepared by applying discontinuous adhesive layers to selected bonding surfaces, assembling the layers in the desired configuration, and consolidating the assembly under heat and pressure. For

| | | | MOF | Carbon | |
|---|---|---|---|---|---|
| Sample | Face Fabric | Vapor Permeable | Loading | Loading | |
| Name | Type | Layer Type | (gsm) | (gsm) | Treatment |
| A | Woven | PU Membrane | 191 | 220 | None |
| B | Woven | PU Membrane | 191 | 0 | None |
| C | Knit | PU Membrane | 142 | 274 | None |
| D | Knit | PU Membrane | 142 | 274 | Laundered |
| E | Woven | PU Membrane | 142 | 274 | None |
| F | Woven | PU Membrane | 142 | 274 | Laundered |
| G | Woven | PU Membrane | 65 | 120 | None |
| H | Knit | PU Membrane | 65 | 120 | None |
| I | Woven | PU Membrane | 0 | 240 | None |

comparative purposes, control constructions were prepared without MOF loading and without activated carbon loading to serve as baseline references for evaluating the performance of the adsorbent-containing samples. Table 1: Laminated materials prepared using embodiments of the multi-layer fabric construction 10. All constructions were laminated using reactive adhesive systems. The MOF material 46 and activated carbon material 36 were incorporated into a melt-blown nonwoven scaffold.
Sample A consisted of a woven face fabric, a polyurethane (PU) membrane, a MOF loading of approximately 191 gsm and a carbon loading of approximately 220 gsm. Sample A did not receive any additional treatments.
Sample B consisted of a woven face fabric, a PU membrane, a MOF loading of approximately 191 gsm and a carbon loading of 0 gsm. Sample B did not receive any additional treatments.
Sample C consisted of a knit face fabric, a PU membrane, a MOF loading of approximately 142 gsm and a carbon loading of approximately 274 gsm. Sample C did not receive any additional treatments.
Sample D consisted of a knit face fabric, a PU membrane, a MOF loading of approximately 142 gsm and a carbon loading of approximately 274 gsm. Sample D received an additional treatment in the form of being laundered.
Sample E consisted of a woven face fabric, a PU membrane, a MOF loading of approximately 142 gsm and a carbon loading of approximately 274 gsm. Sample E did not receive any additional treatments.
Sample F consisted of a woven face fabric, a PU membrane, a MOF loading of approximately 142 gsm and a carbon loading of approximately 274 gsm. Sample F also received an additional treatment in the form of being laundered.
Sample G consisted of a woven face fabric, a PU membrane, a MOF loading of approximately 65 gsm and a carbon loading of approximately 120 gsm. Sample G did not receive any additional treatments.
Sample H consisted of a knit face fabric, a PU membrane, a MOF loading of approximately 65 gsm and a carbon loading of approximately 120 gsm. Sample H did not receive any additional treatments.
Sample I consisted of a woven face fabric, a PU membrane, a MOF loading of 0 gsm and a carbon loading of approximately 240 gsm. It should be noted that Sample I incorporated a double layer of carbon, with individual carbon layers having a loading of approximately 120 gsm. Sample I did not receive any additional treatments.

### Test Methods

In the following test methods, the term “permeation” with respect to chemical protective clothing means the movements of chemicals as molecules through a protective clothing material by the processes of (1) absorption of the chemical into the contact surface of the materials, (2) diffusion of the adsorbed molecules throughout the material, and (3) desorption of the chemical from the opposite surface of the material.

### Aerosol Vapor Liquid Assessment Group (AVLAG)

AVLAG testing was conducted using a dual-flow permeation apparatus in accordance with TOP 8-2-501A, as described and illustrated in U.S. Pat. No. 11,219,785. In this method, opposing air streams are directed across the outer and inner surfaces of a test sample while the exposed surface is challenged with 1 μL liquid droplets of sulfur mustard (HD) or nerve agent (GD), corresponding to a surface loading of approximately 10 gsm (1000 μg/cm²). Cumulative permeation of the agent through the specimen was measured at 1 hour and 24 hours. The measured permeation was normalized to the exposed area to determine permeation values (μg/cm²). Permeative flow was quantified by thermal desorption analysis.

### DMS Permeation

DMS permeation is performed in accordance with the NFPA 1990 testing standard. In the test, DMS is permeated through a sample swatch that was tested using an in-house dual flow test based on ASTM Method F739-12, wherein a circular sample swatch 35 mm in diameter was secured between two halves of an ASTM Permeation Test Cell. The entire system, including the test cell, the sparger of the challenge agent, and the tubing to the analyzer was preconditioned for a 24-hour period at a temperature of 90° F.+/−2° F. using electric heating, with a relative humidity ranging from 80+/−5%.

During the DMS Permeation Test, the entire system was maintained at a temperature of 90° F.+/−2° F. using electric heating, with a relative humidity ranging from 80+/−5%. A challenge stream was created by flowing 0.30 standard liters per minute (SLPM) of DMS across the top of the swatch and 1.0 SLPM across the bottom of the swatch at a DMS challenge concentration of 10 gsm. The challenge was conducted over the course of a 6-hour time period.

### 24-Hour Laundering Test

The 24-hour laundering test is used to determine the fabric construction's durability over time, specifically the ability to withstand laundering. Each sample fabric construction is washed for 24 washing cycles, lasting approximately one hour each, in an automatic washing machine. Each washing cycle includes a washing step without detergent, a rinse step, and a spin step. Throughout the washing cycles, the water temperature is controlled and maintained at approximately 140° F. Once the 24 washing cycles have been completed, the sample fabric constructions were air dried. Preferably, the laundering test is performed in a SDL Atlas washer.

Once laundering has been completed, the sample fabric constructions were subjected to additional testing to ensure the fabric construction has maintained the desired properties through the laundering process.

### TIC Challenge

The Toxic Industrial Chemicals (TIC) Challenge is performed in accordance with the NFPA 1990 testing standard. In the test, a panel of notable TICs were permeated through sample fabric constructions using an in-house dual flow test based on ASTM method F739-12, wherein a circular sample swatch 35 mm in diameter was secured between two halves of an ASTM Permeation Test Cell. The TICs tested in this challenge include acrylonitrile, ammonia, and anhydrous chlorine.

During the Toxic Industrial Chemical (TIC) challenge testing, a dual-flow challenge configuration was employed in which 1.0 standard liters per minute (SLPM) of the selected TIC was flowed across the exposed surface of the test sample and 1.0 SLPM was flowed across the opposing surface. The TIC challenge concentration was maintained at 40 ppm (+10/−0 ppm). Each challenge was conducted for a duration of 1 hour.

### Air Permeability

Air permeability was measured using ASTM D 737, Air Permeability of Textile Fabrics.

### Thermal Resistance

Thermal resistance testing using a sweating guarded hot plate (SGHP) ASTM F1868 Procedure Part C (Dry) was used to measure thermal resistance (Rct) in which the hot plate was kept at 35° C. in a climatic chamber regulated to 25° C. in ambient humidity while air is flowed across the top of the fabric at 1 m/s. Thermal resistance (Rct) in units of Km²/W can be converted to clothing insulation units (clo) by dividing by 0.155. 1 clo unit is the amount of insulation that allows a person at rest to maintain thermal equilibrium in an environment at 21° C. (70° F.) in a normally ventilated room (0.1 m/s air movement). The lower the clo value of a fabric or composite, the lower the thermal burden on the person wearing the clothes.

### Peel Strength Test

The Peel Strength Test was determined using ASTM D1876, in which the peel separation strength of two flexible materials have been bonded together through the use of an adhesive. This testing method focused on two different factors: (1) the peel strength of different layers of the multi-layer fabric construction 10 and (2) the peel strength after various rounds of treatment. For the location peel testing, samples of the multi-layer fabric construction 10 were tested between the inner fabric 20 and the gas-permeable carbon layer 30 and between the outer face fabric 60 and the vapor-permeable layer 50. For the treatment peel testing, the sample multi-layer fabric construction 10 were tested either in their initial “received in” state or after being subjected to a cycle of laundering treatment.

Under ASTM D1876, the peel strength testing procedure includes loading each of the samples into the opposing tensile grips (utilizing either manual vise grips or pneumatic grips) of an eXpert 7600 Single Column Testing Machine. To commence testing, the grip separation of the samples was begun with a constant rate of speed (as defined by the specification of ASTM D1876) and end after enough material has been peel to allow for the calculation of the peel strength force analysis.

### Moisture Vapor Transmission Rate (MVTR)

MVTR was determined using ASTM E 96 Method B for 24 hours, using samples of face area 30 cm² at 23° C., 50% relative humidity difference between the two sides of the sample.

### Test Results

Tests were conducted on selected fabric constructions described in Table 1. The tests included Aerosol Vapor Liquid Assessment Group (AVLAG), DMS permeation, 24-hour Laundering Test, TIC Challenge Test, air permeability, thermal resistance (Rct), peel strength test, and, Moisture Vapor Transmission Rate (MVTR), all using the equipment and test procedures described above.

Samples were evaluated for permeation of GD, HD, and, where applicable, DMS using the AVLAG test method. Permeation was measured over specified exposure intervals (0-1 hour and 0-24 hours for GD and HD; 0-1 hour and 0-6 hours for DMS). The results are presented in Table 2, where lower cumulative permeation values correspond to improved barrier performance.

TABLE 2
Performance of multilayer fabrication construction 10 under a liquid
chemical warfare agent and toxic industrial chemical challenge.

| | GD Permeation | | HD Permeation | | DMS Permeation | |
|---|---|---|---|---|---|---|
| | (ug/cm2)* | | (ug/cm2)⁺ | | (ug/cm2)^{‡} | |
| Sample | 0-1 hr | 0-24 hr | 0-1 hr | 0-24 hr | 0-1 hr | 0-6 hr |
| A | <0.25 | <0.50 | <0.25 | <0.50 | <0.025 | <0.05 |
| B | 54 | 59 | 18 | 31 | 6.7 | 6.9 |
| C | <0.015 | <0.03 | <0.015 | <0.030 | N/A | N/A |
| D | <0.015 | 0.03 | <0.015 | 0.09 | N/A | N/A |
| E | 0.02 | 0.04 | <0.015 | <0.030 | N/A | N/A |
| F | <0.015 | <0.03 | <0.015 | 0.06 | N/A | N/A |
| G-1 | 0.222 | 0.291 | 0.150 | 0.532 | 1.2 | 1.8 |
| G-2 | 0.147 | 0.201 | 0.053 | 0.152 | 5.8 | 9.0 |
| G-3 | 0.057 | 0.081 | 0.411 | 1.203 | N/A | N/A |
| H-1 | 7.442 | 9.396 | 0.568 | 2.828 | 1.5 | 3.9 |
| H-2 | 0.520 | 0.817 | 2.313 | 10.029 | 1.6 | 3.6 |
| H-3 | 12.414 | 18.067 | 0.058 | 0.277 | N/A | N/A |
| I | 0.016 | 0.031 | 0.068 | 0.192 | N/A | N/A |

*Test done under TOP 8-2-501A conditions. Dual-flow, 10 g/m² challenge.
⁺Test done under TOP 8-2-501A conditions. Dual-flow, 10 g/m² challenge.
^{‡}Test done under NFPA 1990 Standard conditions. Dual-flow, 10 g/m² challenge.

The results in Table 2 demonstrate that permeation performance varies depending on adsorbent composition and loading. Several constructions exhibited very low cumulative permeation values, while others showed substantially higher permeation, indicating that adsorbent configuration and layer architecture significantly influence protective performance.

Samples were subsequently evaluated using the AVLAG test method to measure GD and HD permeation over a 24-hour exposure period in order to assess the impact of laundering on protective performance. The results are presented in Table 3, where lower cumulative permeation values indicate improved barrier performance.

TABLE 3
Performance of multi-layer construction 10 under a liquid
chemical warfare agent and toxic industrial chemical challenge
before and after a 24-hour laundering test.

| | | GD Permeation | | HD Permeation | |
|---|---|---|---|---|---|
| | | (ug/cm2) | | (ug/cm2) | |
| Sample | Treatment | 0-1 hr | 0-24 hr | 0-1 hr | 0-24 hr |
| C | None | <0.015 | <0.03 | <0.015 | <0.030 |
| D | Laundered | <0.015 | 0.031 | <0.015 | 0.089 |
| E | None | 0.023 | 0.042 | <0.015 | <0.030 |
| F | Laundered | <0.015 | <0.030 | <0.015 | 0.064 |

The permeation results indicate that short-term (0-1 hour) protective performance was substantially maintained following laundering. While some increase in cumulative 24-hour permeation was observed, particularly for HD, the laundered samples continued to exhibit low permeation levels, demonstrating retention of protective functionality after washing.

Samples were evaluated for the effects of decontamination for various CWAs and TICs after 24-hours and 6-hours respectively. The results are set forth in Table 4, where a higher decontamination value is preferred.

TABLE 4
Decontamination rates of chemical warfare agents and toxic
industrial chemicals by the different multilayer constructions
10. Extraction of chemical warfare agents from swatches
were done after the liquid challenge.

| | GD | HD | DMS |
|---|---|---|---|
| | Decontamination | Decontamination | Decontaminated |
| Sample | after 24 hours | after 24 hours | after 6 hours |
| A | 93.95% | 92.05% | 99.90% |
| B | 99.49% | 99.90% | 99.85% |
| C | 85.3% | 83.4% | N/A |
| D | 63.2% | 66.6% | N/A |
| E | 80.3% | 90.2% | N/A |
| F | 60.5% | 66.5% | N/A |

The results in Table 4 indicate that decontamination performance varies as a function of MOF loading, carbon loading, and fabric construction, and that different agent classes (e.g., GD, HD, DMS) may exhibit differing response profiles depending on the adsorbent configuration.

Next, samples were evaluated the decontamination of GD and HD after 24 hours to determine the effect of laundering on the fabric construction samples. The results are set forth in Table 5, where a lower permeation value is preferred.

TABLE 5
Decontamination performance data for multilayer fabricated construction
10 evaluated before and after 24-hour laundering.

| | | GD | HD |
|---|---|---|---|
| | | Decontamination | Decontamination |
| Sample | Treatment | after 24 hours | after 24 hours |
| C | None | 85.3% | 83.4% |
| D | Laundered | 63.2% | 66.6% |
| E | None | 80.3% | 90.2% |
| F | Laundered | 60.5% | 66.5% |

The results indicate a reduction in decontamination performance following the 24-hour laundering procedure. However, substantial decontamination activity was retained after laundering, demonstrating that the laminated fabric construction maintains meaningful adsorption and/or degradation capability under laundering conditions.

The retention of performance after laundering demonstrates that the adsorbent particles remain mechanically stabilized within the nonwoven scaffold and are not substantially lost or deactivated under washing conditions. Samples were evaluated for permeation of selected Toxic Industrial Chemicals (TICs) at 15 minutes and 60 minutes to assess the impact of adsorbent configuration, including the presence or absence of activated carbon in combination with MOF. The results are set forth in Table 6. Lower permeation values indicate improved barrier performance.

TABLE 6
TIC Performance Data.

TIC Permeation (ug/cm2)

| Sample | Chemical | 0-15 min | 0-1 hr |
|---|---|---|---|
| B | Acrylonitrile | <MD* | <MD |
| B | Ammonia, Anhydrous | <MD | <MD |
| B | Chlorine | 0.06 | 0.06 |
| A | Acrylonitrile | <MD | <MD |
| A | Ammonia, Anhydrous | <MD | <MD |
| A | Chlorine | 0.06 | 0.06 |

*Minimums Detection (MD) is 0.01 ug/cm²

Comparison of Sample B (MOF-only layer) and Sample A (MOF layer combined with activated carbon layer) indicates no measurable difference in TIC permeation performance for acrylonitrile, anhydrous ammonia, or chlorine within the detection limits of the test. The addition of activated carbon to the MOF-containing layer did not materially affect short-term TIC permeation under the conditions evaluated.

The effect of outer face cover fabric on air permeability and thermal resistance is shown in Table 7 for Sample A. A lower value of thermal resistance is preferred.

TABLE 7
Evaporative Resistance and Total Heat Loss
results for multi-layer construction 10.

| | Evaporative | | | |
|---|---|---|---|---|
| | Resistance (Pa · m²/W) | | Total Heat Loss Test (W/m²) | |
| Sample | Measured | Target | Measured | Target |
| A | 26.23 | ≤30 | 239.4 | ≥200 |

These results demonstrate that the use of a woven cover fabric in the sample fabric construction met the target conditions for both air permeability and thermal resistance.

The effect of peel location and differing levels of treatment received by the samples is shown in Table 8 for Samples C and E.

TABLE 8
Peel strength data for multi-layer fabric construction 10.

| Sample | Peel Test Location | Peel Test Treatment | Peel Strength (lbF) |
|---|---|---|---|
| C | Layer 20 to Layer 30 | Average Fill Peel As Received | 1.229 |
| C | (backer to carbon) | Average Fill Peel After Laundering | 1.021 |
| C | | Average Fill Peel As Received | 1.276 |
| C | | Average Fill Peel After Laundering | 1.375 |
| C | Layer 50 to Layer 60 | Average Fill Peel As Received | 0.845 |
| C | (face to membrane) | Average Fill Peel After Laundering | 1.014 |
| C | | Average Fill Peel As Received | 1.196 |
| C | | Average Fill Peel After Laundering | 0.9 |
| E | Layer 20 to Layer 30 | Average Fill Peel As Received | 1.078 |
| E | (backer to carbon) | Average Fill Peel After Laundering | 0.941 |
| E | | Average Fill Peel As Received | 1.25 |
| E | | Average Fill Peel After Laundering | 1.185 |
| E | Layer 50 to Layer 60 | Average Fill Peel As Received | 0.803 |
| E | (face to membrane) | Average Fill Peel After Laundering | 0.861 |
| E | | Average Fill Peel As Received | 1.405 |
| E | | Average Fill Peel After Laundering | 1.318 |

The results of this test indicate there was no significant loss in peel strength based on peel test location (i.e., between the inner face and the carbon layer or the outer face and the gas-permeable membrane) or based on the difference in, showing the durability and robustness of the fabric.

The effect of different composite layering (MOF loading, carbon loading) on MVTR is shown in Table 9 for Samples A and B.

TABLE 9
MVTR Data for multi-layer fabric construction 10.

| Sample | MVTR (g/m2/day) |
|---|---|
| A | 1166 |
| B | 1281 |

The results demonstrate that the change of carbon loading between Sample A (220 gsm) and Sample B (0 gsm) result in differences that are not statistically significant. The data establish that the difference in carbon loading do not significantly decrease the MVTR, which would have a negative impact on thermal burden on a garment made with the fabric construction.

What is claimed is:

1. A multi-layer fabric construction configured to mitigate toxic chemical agents, comprising:
(a) a gas-permeable adsorbent layer comprising a nonwoven porous scaffold of entangled polymeric microfibers defining interconnected voids and a plurality of adsorbent particles mechanically retained within the scaffold at one or more depths; and
(b) a vapor-permeable layer disposed adjacent to the gas-permeable adsorbent layer.

2. The multi-layer fabric construction of claim 1, wherein the adsorbent particles comprise metal-organic framework (MOF) material.

3. The multi-layer fabric construction of claim 1, wherein the plurality of adsorbent particles comprises activated carbon material.

4. The multi-layer fabric construction of claim 1, wherein the plurality adsorbent particles comprises a mixture of MOF material and activated carbon material.

5. The multi-layer fabric construction of claim 1, wherein the plurality of adsorbent particles are stratified within the nonwoven porous scaffold at multiple depths.

6. The multi-layer fabric construction of claim 1, wherein the nonwoven porous scaffold comprises melt-blown or spun-blown polymeric microfibers.

7. The multi-layer fabric construction of claim 1, wherein the nonwoven porous scaffold comprises polymeric microfibers having diameters of less than 20 microns.

8. The multi-layer fabric construction of claim 1, further comprising a gas-permeable carbon layer disposed adjacent to the gas-permeable adsorbent layer.

9. The multi-layer fabric construction of claim 1, wherein the plurality of adsorbent particles comprise MOF granules blended with thermally activatable adhesive particles.

10. The multi-layer fabric construction of claim 1, wherein the plurality of particles comprises a MOF material wherein the MOF loading is at least about 50 grams per square meter.

11. The multi-layer fabric construction of claim 1, wherein the vapor-permeable layer comprises a moisture vapor-permeable membrane.

12. The multi-layer fabric construction of claim 1, further comprising an outer fabric layer positioned outward of the vapor-permeable layer.

13. The multi-layer fabric construction of claim 1, wherein the vapor-permeable layer and the gas-permeable adsorbent layer are laminated together by a discontinuous adhesive pattern.

14. The multi-layer fabric construction of claim 1, wherein the multi-layer fabric construction is substantially free of air gaps between the vapor-permeable layer and the gas-permeable adsorbent layer.

15. The multi-layer fabric construction of claim 1, wherein toxic industrial chemical permeation for acrylonitrile, ammonia, and chlorine is less than 0.06 μg/cm².

16. The multi-layer fabric construction of claim 1, wherein chemical warfare agent permeation for HD, GD, and DMS is less than 4 μg/cm² under a dual-flow challenge.

17. The multi-layer fabric construction of claim 1, wherein the vapor-permeable layer withstands hydrostatic pressure of at least 6000 mm.

18. A multi-layer fabric construction comprising a vapor-permeable layer, a gas-permeable adsorbent layer, and a separate gas-permeable carbon layer, wherein the gas-permeable adsorbent layer contains a plurality of MOF particles.

19. The multi-layer fabric construction of claim 18, wherein the MOF particles are dispersed uniformly within the gas-permeable adsorbent layer.

20. The multi-layer fabric construction of claim 18, wherein the gas-permeable carbon layer comprises activated carbon beads.

21. The multi-layer fabric construction of claim 18, wherein the gas-permeable carbon layer is secured to the gas-permeable adsorbent layer by a gas-permeable adhesive.

22. A method of manufacturing a multi-layer fabric construction, the method comprising the steps of:
providing a gas-permeable adsorbent layer containing a plurality of adsorbent particles;
providing a subassembly comprising a vapor-permeable layer and an outer fabric layer; and,
securing the gas-permeable adsorbent layer to the subassembly.

23. The method of claim 22, wherein the step of securing is accomplished by roll lamination or heat pressing.

24. The method of claim 22, wherein the plurality of adsorbent particles comprise MOF material and activated carbon material.

25. The method of claim 22, wherein the plurality of adsorbent particles are distributed at multiple depths within the gas-permeable adsorbent layer.
